(19) United States
(12) Patent Application Publication
(10) Pub. No.: US 2012/0051208 A1
(43) Pub. Date: Mar. 1, 2012

(54) METHODS AND SYSTEMS FOR MULTIPLE ACCESS ENCODING, TRANSMISSION AND DECODING

(76) Inventors: DAOBEN LI, (US); WEI LU, (US)

(21) Appl. No.: 12/869,750

(22) Filed: Aug. 27, 2010

(51) Int. Cl. H04J 11/00

(52) U.S. Cl. 370/208

(57) ABSTRACT

This invention relates to a multiple access encoding method, which includes: expand the complete complementary orthogonal code mate to generate generalized complementary orthogonal code group, where the auto-correlation function of the generalized complementary orthogonal code group mentioned is the impulse response, and the cross-correlation function is zero everywhere; expand the generalized complementary orthogonal code group and the extension matrix to generate the expanded generalized complementary orthogonal code group; perform multiple access encoding to the transmitted data by using the expanded generalized complementary orthogonal code group and its shift code group. The invention also discloses a multiple-access transmission method, multiple access decoding method, multiple access coding equipment, multiple access transmission equipment, multiple access decoding equipment and the corresponding communication system. By using this invention, the multiple-access systems can share the channel capacity C, the interference of the system can be minimized, the performance of system can be greatly enhanced, and the spectral efficiency of system can be improved tremendously.

### FIELD OF THE INVENTION

This invention relates to communications technology, specifically relating to methods and systems of multiple access coding, transmission and decoding technology for wireless and mobile communications.

### BACKGROUND OF THE INVENTION

It is well known that there is an insurmountable highest limit of transmission for any given communication channel which is called channel capacity C. The conclusion of single user's information theory is that the actual data rate can approach to but not exceed C by the long constraint of optimal coding. While the conclusions of multi-users' information theory hold that the system total data rates may be greater or even far greater than C when the users' waveform satisfies the best coding relationship although each single address user's data rate can't be greater than C. That is to say, address users can share channel capacity C.

Conventional multiple access technologies such as Frequency Division Multiple Access (FDMA), Orthogonal Frequency Division Multiple Access (OFDMA), Time division Multiple Access (TDMA), Code Division Multiple Access (CDMA) and so on can only distribute C but not share it. In other words, each address user's data rate can't be greater than C, their system total data rates can't be greater than C as well.

Theoretically, the problem of sharing C can be solved only by adopting the best asynchronous (including synchronous) multiple access user waveform and multi-user detection. It is regretfully that no one had ever found the best waveform prior to this disclosed invention.

It is well known to all that the code utilization is the only indicator to measure multiple access systems which can be or not sharing channel capacity C. The definition of code utilization is the ratio of number of address and address code length (including generalized code length of frequency slot, time slot and chip number). The multiple access system can only distribute but not share channel capacity C when the code utilization rate is less than or equal to 1. Regrettably, the entire conventional multiple access systems have the rate equals to 1 maximally.

What is more, there are still many problems in the existing multiple access solutions, for example:

1. Multi-user joint detection in the existing technologies adopts joint detection by symbols mostly, not by using the ideal multi-user sequence joint detection generally, so we need to use the whole channel and users parameters when detecting them which includes adjacent cell channel and the users parameters including number of address users, their respective arrival time and the signal power of which most are random or uncontrollable, and so it is hard to achieve the ideal detection. Some of the simpler detections will take all or part of the signals in the adjacent cell as interference which will affect system performance seriously, and will eventually make multi-users joint detections unable or hard to be realized or being of poor performance.

2. The design of asynchronous multiple access user waveform relates to address number and their relative time delay, while the cross-correlation function determined by the address number and the auto-correlation function determined by relative time delay can't achieve the best performance resulting in system disturbance, and therefore the spectrum efficiency and system performance can't be optimized.

We will explain in more details in the following sections.

### SUMMARY OF THE INVENTION

An object of the invention is to overcome at least some of the drawbacks relating to the compromise designs of prior art systems and methods as discussed above.

The implementation of this invention provides a method of multiple access coding to make the multiple access system share channel capacity C, reduce system disturbance, improve system performance greatly, and improve the efficiency of system frequency spectrum which includes:

a) Produce generalized complementary orthogonal code group through expanding complete complementary orthogonal code dual whose auto-correlation function is impulse function and cross correlation function is zero everywhere;
b) Produce expanded generalized complementary orthogonal code group through expanding generalized complementary orthogonal code group and expanded matrix;
c) Execute multiple access coding processing on transmit data by using expanded generalized complementary orthogonal code group and their shifted code group.

The implementation of this invention also provides a multiple access transmission method to make the multiple access system share channel capacity C, reduce system disturbance, improve system performance greatly, and improve the efficiency of system frequency spectrum which includes:

Transmit the data achieved from the above multiple access coding method and treated by multiple access coding to be transmitted separately on each flat synchronous decline channel.

The implementation of this invention also provides a multiple access decoding method to make the multiple access system share channel capacity C, reduce system disturbance, improve system performance greatly, and improve the efficiency of system frequency spectrum which includes:

a) Receive the transmitted data on each sub-channel with flat synchronous fading characteristics;
b) Decode the received data, and expose inspection and operations on the component code of the address code respectively firstly, then expose shift and superposition; or we may shift them respectively first, then expose inspection and operations, and superimpose the computational results.

The implementation of this invention also provides a multiple access encoding device to make the multiple access system share channel capacity C, reduce system disturbance, improve system performance greatly, and improve the efficiency of system frequency spectrum which includes:

a) Extension module, which is used to expand the complete complementary orthogonal code dual to generate generalized complementary orthogonal code group, whose auto-correlation function is an impulse function and cross-correlation function is zero everywhere;
b) Direct product modules, which is used to expand the generalized complementary orthogonal code group and the expanded matrix to produce expansion generalized complementary orthogonal code group;
c) Coding processing module, which is used to execute multiple access coding processing on transmit data by using expanded generalized complementary orthogonal code group and their shifted code group.

The implementation of this invention also provides a multiple access encoding device to make the multiple access system share channel capacity C, reduce system disturbance, improve system performance greatly, and improve the efficiency of system frequency spectrum which includes:

Transmission module, which is used to transmit the data achieved from the above multiple access coding method and treated by multiple access coding to be transmitted separately on each flat synchronous decline sub-channel.

The invention also provides a multiple access encoding device to make the multiple access system share channel capacity C, reduce system disturbance, improve system performance greatly, and improve the efficiency of system frequency spectrum which includes:

a) Receiving module, which is used to receive the transmitted data on each above flat synchronous decline sub-channel;
b) Decoding module, which is used to decode the received data, and expose inspection and operations on the component code of the address code respectively first, then expose shift and superposition; or shift them respectively first, then expose inspection and operations, and superimpose the computational results.

The invention also provides a communications system to make the multiple access system share channel capacity C, to reduce system disturbance, to improve system performance greatly, and improve the efficiency of system frequency spectrum which includes:

a) Multiple access coding device, which is used to expand the complete complementary orthogonal code dual to generate generalized complementary orthogonal code group, whose autocorrelation function is impulse function and cross correlation function is zero everywhere; expand the generalized complementary orthogonal code group and the expanded matrix to produce expand generalized complementary orthogonal code group; execute multiple access coding processing on transmit data by using expanded generalized complementary orthogonal code group and their shifted code group;
b) Multiple access transmission device, which is used to transmit the data achieved from the above multiple access coding method and treated by multiple access coding to be transmitted separately on each flat synchronous decline sub-channel;
c) Multiple access decoding device, which is used to receive the transmitted data on each above flat synchronous decline sub-channel; decode the received data when exposing inspection and operations on the component code of the address code respectively first, then exposing shift and superposition; or shift them respectively first, then expose detection operations, and add together all the results.

The implementation of the present invention takes the multiple access encoding process for the transmission data employing the expanded generalized complementary orthogonal code group and its shift code group which can achieve the purpose of sharing the channel capacity C. Besides, we can shift the pressure of multi-user detection from inter-cell address users to intra-cell address users by allocating the generalized complementary orthogonal code group and its shift code group to different cells; and the encoding scheme can make the cross-correlation function between address code group be ideal in a generalized complementary sense which can avoid interference between address users; and the auto-correlation function between address code group can realize coding constraint relation with high coding gain which can boost the transmission reliability and greatly enhance the system performance.

The details of the present invention are disclosed in the following drawings, descriptions as well as the claims based on the abovementioned elements.

The various aspects, features and advantages of the disclosure will become more fully apparent to those having ordinary skill in the art upon careful consideration of the following detailed description thereof with the accompanying drawings described below.

### BRIEF DESCRIPTION OF THE DRAWINGS

In order to explain this invention in a more technical way, the attached figures will be described in the implementation of the present invention and analysis of existing technology. Obviously, the attached figures in the below descriptions are only some implementation examples of this invention. In the drawings:

FIG. 1 is the flow chart of multiple access coding method of the present invention;

FIG. 2 is the schematic of expand complementary orthogonal code dual and its shift of the present invention;

FIG. 3 is the schematic of component code \tilde{b}₀⁰(Ã) and \tilde{b}₀¹(Ã)'s parallel convolution encoder structure in FIG. 2 for the implementation of the present invention;

FIG. 4 is the schematic of component code \tilde{b}₀⁰(Ã′) and \tilde{b}₀¹(Ã′)'s parallel convolution encoder structure in FIG. 2 or the implementation of the present invention;

FIG. 5 is the flow chart of multiple access decoding method of the present invention;

FIG. 6 is the structure diagram of multiple access coding devices of the present invention;

FIG. 7 is the structure diagram of multiple access transmission devices of the present invention;

FIG. 8 is the structure diagram of multiple access decoding device of the present invention;

FIG. 9 is the structure diagram of communication system of the present invention.

Like reference numerals refer to like parts throughout the several views of the drawings.

### DETAILED DESCRIPTION OF THE INVENTION

The present inventions now will be described more fully hereinafter with reference to the accompanying drawings, in which some examples of the embodiments of the inventions are shown. Indeed, these inventions may be embodied in many different forms and should not be construed as limited to the embodiments set forth herein; rather, these embodiments are provided by way of example so that this disclosure will satisfy applicable legal requirements. Like numbers refer to like elements throughout.

In order to describe the technical solutions and advantages of this invention more clearly, the disclosure will be explained in details with the drawings. Here, the implementation example and its description of the invention are just to explain the invention, but not to limit the invention.

In order to improve code word utilization and make the multiple access system share channel capacity C, and avoid the system's interference caused by multi-user detection and asynchronous multiple access user waveform design in the existing technology, the present invention proposes an overlapping coding multiple access solution called OVCDMA (Overlapped Code Division Multiple Access. This solution can provide higher address code word utilization which is far more than 1, and the pressure of multi-user joint detection may be translated from inside the village into interval if allocating the different expanded generalized complementary orthogonal code group to different district. Address users signals in different district won't generate disturbance even if in asynchronous and multi-user data rate system.

The OVCDMA solution in the present invention will be introduced in details as follows.

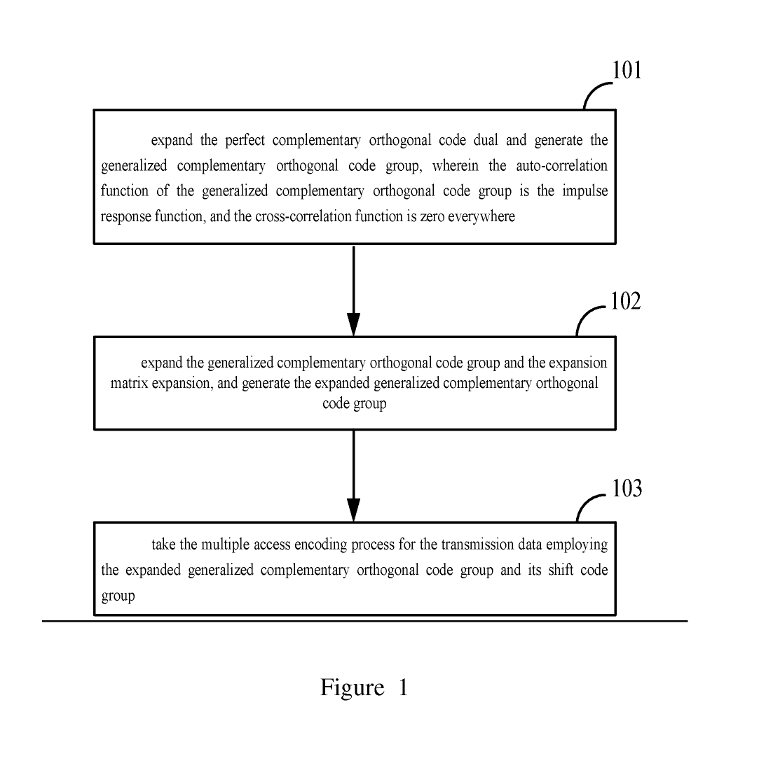

As shown in FIG. 1, multiple access coding (encoding) method process in the invention's OVCDMA solution is as follows:

Step 101, expand the complete complementary orthogonal code dual to generate generalized complementary orthogonal code group, whose auto-correlation function is a impulse function and cross-correlation function is zero everywhere;

Step 102, expand the generalized complementary orthogonal code group and the expanded matrix to produce expand generalized complementary orthogonal code group;

Step 103, execute multiple access coding processing on transmit data by using expanded generalized complementary orthogonal code group and their shifted code group;

The specific implementation as shown in FIG. 1 is to allocate the different expanded generalized complementary orthogonal code group and their shift code group to different address users, which can assure that there is no disturbance among the address users' signal for any relative shift (asynchronous conditions) even for different data rates, so the code word utilization may be improved greatly, namely, from less than 1 to far greater than 1. As a result, it is the real CDMA technology to share channel capacity C. At the same time, it can provide much higher encoding gain which can make the multiple access users system's capacity more close to the theoretical multi-user bandwidth limit.

In order to implement the processing as shown in FIG. 1, expanded generalized complementary orthogonal code group need to be composed. As expanded generalized complementary orthogonal code group is generated by expanded operations (such as, direct product, sub-matrix concatenated interleaving transformation) of generalized orthogonal code and expanded complementary matrix, while generalized orthogonal code group is generated by complete complementary orthogonal code dual's expansion, the Perfect Complete Complementary Orthogonal Code Pairs Mate should be constructed first in constructing generalized complementary orthogonal code group. It is well known that the complementary means the results of the two homogeneous options meeting special requirements after pulsed, the special requirements in the present invention are that the autocorrelation function is impulse function (the value is zero everywhere except the origin) and cross correlation function is zero everywhere.

Complete complementary orthogonal code's mathematics, as set forth above is:

\tilde{b}ₖ=Cₖ[+]Sₖ, k=0, 1.

Where: \tilde{b}ₖ [symbol] [\tilde{b}_{k, 0}, \tilde{b}_{k, 1}, . . . , \tilde{b}_{k, N}_{₀}₋₁] (k=0, 1) the code are all normalized N₀ dimension vector (same below), and normalized means the energy of the vector is 1, that is:

∥\tilde{b}ₖ∥₂=∥Cₖ∥²+∥Sₖ∥²=1,

Symbol Ã [symbol] [ã₀, ã₁, . . . , ã_{N-1}],

$${‖ \tilde{A} ‖}^{2} \hat{=} {\sum }_{i = 0}^{N - 1} {\tilde{a}}_{i} {\tilde{a}}_{i}^{*}$$

[+] means complementation addition, namely, related operations or whatever operations within or between \tilde{b}ₖ (k=0 , 1); the components of which will be processed respectively; interaction operations between component code are not permitted, but the computational results will be pulsed.

The basic properties of the perfect complete complementary orthogonal code dual are as follows: The aperiodic autocorrelation function and cross-correlation function of complete complementary orthogonal code dual {\tilde{b}ₖ} (k=0, 1) are totally ideal in the sense of complementary, that is to say:

\tilde{b}ₖ\tilde{b}_{k′}^{H}(l) [symbol] CₖC_{k′}^{H}(l)+SₖS_{k′}^{H}(l)=δ_{kk′}δ(l), k,k′=0, 1

Where: \tilde{}^{H} is transposing conjugate of the vector \tilde{};

$${δ}_{{kk}^{′}} \hat{=} \{ \begin{matrix}1 , & k = {k}^{′} \\ 0 , & k \neq {k}^{′}\end{matrix} \\ δ ( l ) \hat{=} \{ \begin{matrix}1 , & l = 0 \\ 0 , & l \neq 0\end{matrix} \\ k , {k}^{′} = 0 , 1 \\ {\tilde{b}}_{k} ( l ) \hat{=} \{ \begin{matrix}[ \underbrace{0 , 0 , … … , 0}_{l} , {\tilde{b}}_{k , 0} , {\tilde{b}}_{k , 1} , … , {\tilde{b}}_{k , {N}_{0} - l - 1} ] & l \geq 0 \\ [ {\tilde{b}}_{k , \vert l \vert} , {\tilde{b}}_{k , \vert l \vert + 1} , … … , {\tilde{b}}_{k , {N}_{0} - 1} , \underbrace{0 , 0 , … , 0}_{\vert l \vert} ] & l \leq 0\end{matrix} \\ \vert l \vert = 0 , 1 , … , {N}_{0} - 1$$

\tilde{b}ₖ(l) states \tilde{b}ₖ's aperiodic lth shift code vector.

The generation of perfect complete complementary orthogonal code dual has many methods. In order to facilitate the implementation of process as shown in FIG. 1, the complete complementary orthogonal code dual may be generated subject to the needed code length by following the below steps:

(1) Choose the length of the complete complementary orthogonal code dual L according to encoding constraint length.

(2) According to the relationship

L=L₀×2^{l}; l=0, 1, 2, . . .

The length of a shortest Complete Perfect Complementary Code Pair L₀ will be determined first. There is only one pair component code in the basic complete perfect complementary code pair, which only requires complementary of its autocorrelation features. For example, when L=12 is required, then L₀=3, l=2.

(3) Or according to the relationship

L=L₀₁×L₀₂×2^{l+1}; l=0, 1, 2, . . .

The length of two shortest Complete Perfect Complementary Code Pair L₀₁, L₀₂ will be determined first. For example, when L=30 is required, then L₀₁=3, L₀₂=5 (l=0).

(4) According to the shortest code length determined by (2) or (3) and the engineering requirements, choose the code C°₁, whose length is the shortest code length L₀ randomly, C°₁=C₁₁, C₁₂, . . . C_{1L}_{₀}].

(5) According to the requirements of fully complementary of aperiodic auto-correlation function, solve the code S°₁ mathematically with simultaneous equations which is complete complementary with aperiodic auto-correlation function of C°₁, S°₁=S₁₁, S₁₂, . . . S_{1L}_{₀}]. The elements of S°₁ are worked out through the following simultaneous equations:

$${C}_{11} \cdot {C}_{1 {L}_{0}} = - {S}_{11} \cdot {S}_{1 {L}_{0}}$$

$${C}_{11} \cdot {C}_{1 {L}_{o} - 1} + {C}_{12} \cdot {C}_{1 {L}_{o}} = - ( {S}_{11} \cdot {S}_{1 {L}_{o} - 1} + {S}_{12} \cdot {S}_{1 {L}_{o}} )$$

$${C}_{11} \cdot {C}_{1 {L}_{o} - 2} + {C}_{12} \cdot {C}_{1 {L}_{o} - 1} + {C}_{13} \cdot {C}_{1 {L}_{o}} = - ( {S}_{11} \cdot {S}_{1 {L}_{o} - 2} + {S}_{12} \cdot {S}_{1 {L}_{o} - 1} + {S}_{13} \cdot {S}_{1 {L}_{o}} )$$

$$⋮$$

$${C}_{11} \cdot {C}_{12} + {C}_{12} \cdot {C}_{13} + … + {C}_{1 {L}_{o} - 1} \cdot {C}_{1 {L}_{o}} = - ( {S}_{11} \cdot {S}_{12} + {S}_{12} \cdot {S}_{13} + {S}_{1 {L}_{o} - 1} \cdot {S}_{1 {L}_{o}} )$$

The codes are worked out through the above simultaneous equations which generally have a lot of solutions, and any one of the solutions can be chosen as the code S°₁.

### Example 1

If C°₁=+ + −, where +, − represent +1 and −1 respectively, many possible solutions of S°₁ are:

+0+; −0−; +j+; + j̅+; −j−; − j̅−

Where ̅ [symbol] −, the followings are the same.

### Example 2

If C°₁=+ + +, the possible solutions of S°₁ are:

$$\sqrt{2} - 1 , 1 , - \frac{1}{\sqrt{2} - 1} ; \sqrt{2} + 1 , 1 , - \frac{1}{\sqrt{2} + 1} ; a , \frac{- 2 a}{{a}^{2} - 1} , - \frac{1}{a}$$

and so on.

### Example 3

If C°₁=1, 2, −2, 2, 1; one solution of S°₁ is:

1, 4, 0, 0, −1 and so on.

It is very easy to test the above three examples satisfying the requirement of complementarities. Sometimes, the primary value of C°₁ is an improper one so that S°₁ may have no solution; or although S°₁ has a solution, it does not facilitate the engineering application. At this time, the value of C°₁ needs to be readjusted until we are satisfied with the values of both C°₁ and S°₁.

(6) If by (3), because there are two shortest length L₀₁, L₀₂, then repeat (4), (5) to work out two pairs of (C′°₁, S′°₁) and (C′°₂, S′°₂).

### Where:

C′°₁C′₁₁, C′₁₂, . . . C′_{L}_{₀₁}; S′°₁=S′₁₁, S′₁₂, . . . , S′_{1L}_{₀₁}
C′°₂=C′₂₁, C′₂₂, . . . , C′_{2L}_{₀₂}; S′°₂=S′₂₁, S′₂₂, . . . , S′_{2L}_{₀₂}

And in accordance with the following rules, solve out the Complete Complementary Code Pairs (C°₁, S°₁) with the length of 2L₀₁×L₀₂, where:

$${{C}^{•}}_{1} = {C}_{11}^{′} ( {C}_{21} , {C}_{22}^{′} , … , {C}_{2 {L}_{0 \; 2}}^{′} ) , {C}_{12}^{′} ( {C}_{21}^{, ′} , {C}_{22}^{′} , … , {C}_{2 {L}_{02}}^{′} ) , … , {C}_{1 {L}_{01}}^{′} ( {C}_{21}^{′} , {C}_{22}^{′} , … , {C}_{2 {L}_{02}}^{′} ) , {S}_{11}^{′} ( {S}_{21}^{′} , {S}_{22}^{′} , … , {S}_{2 {L}_{02}}^{′} ) , {S}_{12}^{′} ( {S}_{21}^{′} , {S}_{22}^{′} , … , {S}_{2 {L}_{02}}^{′} ) , … , {S}_{1 {L}_{01}}^{′} ( {S}_{21}^{′} , {S}_{22}^{′} , … , {S}_{2 {L}_{02}}^{′} ) , \\ {{S}^{•}}_{1} = {C}_{11}^{′} ( {S}_{2 {L}_{0 \; 2}}^{′} , {S}_{2 {L}_{02} - 1}^{′} , … , {S}_{22}^{′} , {S}_{21}^{′} ) , {C}_{12}^{′} ( {S}_{2 {L}_{02}}^{′} , {S}_{2 {L}_{02} - 1}^{′} , … , {S}_{22}^{′} , {S}_{21}^{′} ) , … , {C}_{1 {L}_{01}}^{′} ( {S}_{2 {L}_{02}}^{′} , {S}_{2 {L}_{02} - 1}^{′} , … , {S}_{22}^{′} , {S}_{21}^{′} ) , {S}_{11}^{′} ( {C}_{2 {L}_{02}}^{′} , {C}_{2 {L}_{02} - 1}^{′} , … , {C}_{22}^{′} , {C}_{21}^{′} ) , - {S}_{12}^{′} ( {C}_{2 {L}_{02}}^{′} , {C}_{2 {L}_{02} - 1}^{′} , … , {C}_{22}^{′} , {C}_{21}^{′} ) , … , - {S}_{1 {L}_{01}}^{′} ( {C}_{2 {L}_{02}}^{′} , {C}_{2 {L}_{02} - 1}^{′} , … , {C}_{22}^{′} , {C}_{21}^{′} ) ,$$

The lengths of them are both 2L₀₁×L₀₂. They are written mathematically as:

C°₁=C′°₁ [symbol] C′°₂, S′°₁ [symbol] S′°₂ S°₁=C′°₁ [symbol] S′°₂, S̅′̅°₁ [symbol] C′°₂
Where [symbol] denotes direct product also known as Kronecker Product; the underline denotes inverted sequence, that is, the order is reversed (from the tail to the head); the over line θ̅ denotes negation sequence, that is, the values of all the elements take anti-value (negative value);

(7) According to the Shortest Basic Complete Complementary Code Pair (C°₁, S°₁) generated by (5), (6), solve out another Shortest Basic Complete Complementary Code Pair (C°₂, S°₂) which is completely complementary and orthogonal with (C°₁, S°₁). {(C°₁, S°₁); (C°₂, S°₂)}. This new pair of Shortest Basic Complete Complementary Code Pair also has complete non-periodic auto-correlation property and complete non-periodic cross-correlation property between the former pair and it from the complementary sense. The two pairs of complementary codes constitute the Perfect Complete Complementary Orthogonal Code Pairs Mate, namely, from the complementary sense, the non-periodic auto-correlation function of each pair of them and the non-periodic cross-correlation function between the two pairs are both ideal.

It can be proved that, for any complementary code pair (C°₁, S°₁), there is only one complementary code pair (C°₂, S°₂) to spouse with it, and they meet the following relationship:

C°₂=αS*°₁; S°₂=α C̅*̅°̅₁̅;

Where: * denotes complex conjugate; α is an arbitrary complex constant; ̅ -, θ denotes the inverted sequence of (the order is reversed from the tail to the head).

For example: If C°₁=+ + −; S°₁=+j+;

let α=1, then C°₂=+ j̅+; S°₂=+ − −.

As the length of the code is very short (N₀=3), it is easy to verify that the non-periodic auto-correlation and cross-correlation functions of the two pairs of codes are both completely ideal.

(8) The Perfect Complete Complementary Orthogonal Code Pairs Mate with the required length L=L₀×2^{l} (l=0, 1, 2, . . . ) can be formed from the Perfect Complete Complementary Orthogonal Code Pairs Mate with the code length L₀.

If (C°₁, S°₁) and (C°₂, S°₂) are a Perfect Complete Complementary Orthogonal Code Pairs

Mate, then in the system implementation we can use the following four simple ways to make it double the length, but the two new pairs after the length-doubling are still a Perfect Complete Complementary Orthogonal Code Pairs Mate.

Method 1: concatenate the short codes by the following way:

C₁=C°₁C°₂; S₁=S°₁S°₂

C₂=C°₁ C̅°̅₂̅; S₁=S°₁ S̅°̅₂̅

Method 2: the parity bit of the code C₁(S₁) is respectively constituted of C°₁(S°₁) and C°₂(S°₂); the parity bit of the code C₂(S₂) is respectively constituted of C°₁(S°₁) and C°₂(S°₂).

For example: if C°₁=[C₁₁C₁₂ . . . C_{1L}_{₀}], S°₁=[S₁₁S₁₂ . . . S_{1L}_{₀}];

C°₂=[C₂₁C₂₂ . . . C_{2L}_{₀}], S°₂=[S₂₁S₂₂ . . . S_{2L}_{₀}].

Then C₁=[C₁₁C₂₁C₁₂C₂₂ . . . C_{1L}_{₀}C_{2L}_{₀}], S₁=[S₁₁S₂₁S₁₂S₂₂ . . . S_{1L}_{₀}S_{2L}_{₀}];

C₂=[C₁₁ C̅₂₁C₁₂ C̅₂₂ . . . C_{1L}_{₀} C̅_{2L}_{₀}], S₂=[S₁₁ S̅₂₁S₁₂ S̅₂₂ . . . S_{1L}_{₀} S̅_{2L}_{₀}].

Method 3: concatenate the short codes by the following way:

C₁=C°₁S°₁; S₁=C°₁ S̅°̅₁̅

C₂=C°₂S°₂; S₂=C°₂ S̅°̅₂̅

Method 4: the parity bit of the code C₁ is respectively constituted of C°₁ and S°₁; the parity bit of the code S₁ is respectively constituted of C°₁ and S̅°̅₁̅; the parity bit of the code C₂ is respectively constituted of C°₂ and S°₂; the parity bit of the code S₂ is respectively constituted of C°₂ and S̅°̅₂̅.

There are many other equivalent methods which will not be repeated here. The continuous use of the above methods can eventually form the Perfect Complete Complementary Orthogonal Code Pairs Mate with the required length L.

To construct expanded Perfect Complete Generalized Complementary Orthogonal Code Groups, it is also required to expand Perfect Complete Complementary Orthogonal Code Pairs Mate in order to generate the Perfect Complete Generalized Complementary Orthogonal Code Groups which must meet the requirements that the auto-correlation function is the impact function and the cross-correlation function is zero everywhere.

Such implementation has taken into account that the Perfect Complete Complementary Orthogonal Code Pairs Mate can only generate a pair of address codes whose auto-correlation and cross-correlation functions are both ideal. In order to construct more address codes with ideal auto-correlation and cross-correlation functions, we can use the Perfect Complete Generalized Complementary Orthogonal Code Groups. Then the complementary role is formed among a number of component codes. What are formed are no longer the two pairs of codes with K=2, but the Perfect Complete Generalized Complementary Orthogonal Code Groups with K>2 groups of which each group has K>2 codes. Their non-periodic auto-correlation and cross-correlation functions are both ideal in the generalized complementary sense.

The Perfect Complete Generalized Complementary Orthogonal Code Groups are mathematically expressed as:

$${\tilde{b}}_{k} = {\tilde{b}}_{k}^{0} [ + ] {\tilde{b}}_{k}^{1} [ + ] … [ + ] {\tilde{b}}_{k}^{K - 1} = [ {\sum }_{l = 0}^{K - 1} ] {\tilde{b}}_{k}^{l} , k = 0 , 1 , … , K - 1 ,$$

Where: \tilde{b}ₖ^{l}\hat{=}[\tilde{b}₂^{l}(0), \tilde{b}₂^{l}(1), . . . , \tilde{b}ₖ^{l}(N₀−1)], l=0, 1, . . . , K−1 are both the normalized N₀-dimension row vectors, that is:

$${‖ {\tilde{b}}_{k} ‖}^{2} = {\tilde{b}}_{k} {\tilde{b}}_{k}^{H} = {\sum }_{l = 0}^{K - 1} {‖ {\tilde{b}}_{k}^{l} ‖}^{2} = 1$$

[+] or [Σ] denotes the generalized complementarities addition, that is, for \tilde{b}ₖ (k=0, 1, 2, . . . , K−1), no matter within the “Code” or between the codes, making the related and other operations only involves the component codes \tilde{b}ₖ^{l} (k, l=0, 1, . . . , K−1) with the same superscript l (l=01, 1, . . . , K−1) while it is not allowed to make the mutual operation between the component codes with the different superscript l, but it is needed to add the K results of the operations.

It can be deduced that the non-periodic auto-correlation function and cross-correlation function of the Perfect Complete Generalized Complementary Orthogonal Code Groups {\tilde{b}ₖ} (k=0, 1, . . . , K−1) are completely ideal in the generalized complementary sense, that is

$$\begin{matrix}{\tilde{b}}_{k} {\tilde{b}}_{{k}^{′}}^{H} ( l ) = {\tilde{b}}_{k}^{0} {\tilde{b}}_{{k}^{′}}^{0 , H} ( l ) + {\tilde{b}}_{k}^{1} {\tilde{b}}_{{k}^{′}}^{1 , H} ( l ) + … + {\tilde{b}}_{k}^{K - 1} {\tilde{b}}_{{k}^{′}}^{K - 1 , H} ( l ) \\ = {δ}_{k , {k}^{′}} δ ( l ) ,\end{matrix}$$

$$k , {k}^{′} = 0 , 1 , … , K - 1 , l = 0 , 1 , … , {N}_{0} - 1.$$

The K>2 Perfect Complete Generalized Complementary Orthogonal Code Groups can be generated by the Perfect Complete Complementary Orthogonal Code Pairs Mate.

In the system implementation, there are many ways by which the Perfect Complete Complementary Orthogonal Code Pairs Mate can be expanded to generate the Perfect Complete Generalized Complementary Orthogonal Code Groups, for example:

The K>2 groups Perfect Complete Generalized Complementary Orthogonal Code Groups with different lengths can be generated by the Perfect Complete Complementary Orthogonal Code Pairs Mate, for example:

{\tilde{b}_{k=C}ₖ[+]Sₗ} k=0, 1 is a Perfect Complete Complementary Orthogonal Code Pairs Mate (K=2). In order to be concise and unified, it can be re-expressed as:

$${B}_{2} \hat{=} [ \begin{matrix}{\tilde{b}}_{0} \\ {\tilde{b}}_{1}\end{matrix} ] = [ \begin{matrix}{\tilde{b}}_{0}^{0} & {\tilde{b}}_{0}^{1} \\ {\tilde{b}}_{1}^{0} & {\tilde{b}}_{1}^{1}\end{matrix} ] ,$$

Where: \tilde{b}ₖ⁰=Cₖ, \tilde{b}ₖ¹=Sₖ,

\tilde{b}ₖ=\tilde{b}ₖ⁰[+]\tilde{b}ₖ¹, k=0, 1,

Then a kind of K=4 Perfect Complete Generalized Complementary Orthogonal Code Groups can be produced by the following direct product, that is

$${B}_{4} = [ \begin{matrix}+ & + \\ + & -\end{matrix} ] ⊗ {B}_{2} = [ \begin{matrix}{B}_{2} & {B}_{2} \\ {B}_{2} & {\overline{B}}_{2}\end{matrix} ]$$

Then the corresponding generated K=4 Perfect Complete Generalized Complementary Orthogonal Code Groups are:

$${B}_{4} \hat{=} [ \begin{matrix}{\tilde{b}}_{0} \\ {\tilde{b}}_{1} \\ {\tilde{b}}_{2} \\ {\tilde{b}}_{3}\end{matrix} ] = [ \begin{matrix}{\tilde{b}}_{0}^{0} & {\tilde{b}}_{0}^{1} & {\tilde{b}}_{0}^{2} & {\tilde{b}}_{0}^{3} \\ {\tilde{b}}_{1}^{0} & {\tilde{b}}_{1}^{1} & {\tilde{b}}_{1}^{2} & {\tilde{b}}_{1}^{3} \\ {\tilde{b}}_{2}^{0} & {\tilde{b}}_{2}^{1} & {\tilde{b}}_{2}^{2} & {\tilde{b}}_{2}^{3} \\ {\tilde{b}}_{3}^{0} & {\tilde{b}}_{3}^{1} & {\tilde{b}}_{3}^{2} & {\tilde{b}}_{3}^{3}\end{matrix} ]$$

$${\tilde{b}}_{k} = {\tilde{b}}_{k}^{0} [ + ] {\tilde{b}}_{k}^{1} [ + ] {\tilde{b}}_{k}^{2} [ + ] {\tilde{b}}_{k}^{3} , k = 0 , 1 , 2 , 3$$

As long as B₂ is the Perfect Complete Complementary Orthogonal Code Pairs Mate, it is easy to test that the non-periodic auto-correlation and cross-correlation functions of this 4 groups of codes (there are 4 codes in each group) are both ideal in the generalized complementary sense, that is

$${\tilde{b}}_{k} {\tilde{b}}_{{k}^{′}}^{H} ( l ) = {\tilde{b}}_{k}^{0} {\tilde{b}}_{{k}^{′}}^{0 , H} ( l ) [ + ] {\tilde{b}}_{k}^{1} {\tilde{b}}_{{k}^{′}}^{1 , H} ( l ) [ + ] … [ + ] {\tilde{b}}_{k} {\tilde{b}}_{{k}^{′}}^{3 , H} ( l ) = {δ}_{k , k} , δ ( l )$$

$$k , {k}^{′} = 0 , 1 , 2 , 3 ; l = 0 , 1 , … , N - 1$$

Similarly, the K=⁸ Perfect Complete Generalized Complementary Orthogonal Code Groups can be generated by the following way

$${B}_{8} = [ \begin{matrix}{B}_{4} & {B}_{4} \\ {B}_{4} & {\overline{B}}_{4}\end{matrix} ] = [ \begin{matrix}+ & + \\ + & -\end{matrix} ] ⊗ {B}_{4} = {H}_{2} ⊗ {B}_{4} = {H}_{4} ⊗ {B}_{2} ,$$

Where: H_{K/2}, K=4, 8, 16, . . . is the Hardmard matrix with the order of K/2.

Finally, B₈ is expressed as:

$${B}_{8} = [ \begin{matrix}{\tilde{b}}_{0} \\ {\tilde{b}}_{1} \\ ⋮ \\ {\tilde{b}}_{7}\end{matrix} ] = [ \begin{matrix}{\tilde{b}}_{0}^{0} & {\tilde{b}}_{0}^{1} & … & {\tilde{b}}_{0}^{7} \\ {\tilde{b}}_{1} & {\tilde{b}}_{1} & … & {\tilde{b}}_{1}^{7} \\ … & … & … & … \\ {\tilde{b}}_{7}^{0} & {\tilde{b}}_{7}^{1} & … & {\tilde{b}}_{7}^{7}\end{matrix} ]$$

The corresponding 8 groups of the Perfect Complete Generalized Complementary Orthogonal Code Groups are:

\tilde{b}ₖ=\tilde{b}ₖ⁰[+]\tilde{b}ₖ¹[+] . . . [+]\tilde{b}ₖ⁷, k=0, 1, 2, . . . , 7

As long as B₂ is the Perfect Complete Complementary Orthogonal Code Pairs Mate, it is easy to test that the non-periodic auto-correlation and cross-correlation functions of this 8 groups of codes (there are 8 codes in each group) are both ideal in the generalized complementary sense, that is

$${\tilde{b}}_{k} {\tilde{b}}_{{k}^{′}}^{H} ( l ) = {\tilde{b}}_{k}^{0} {\tilde{b}}_{{k}^{′}}^{0 , H} ( l ) [ + ] {\tilde{b}}_{k}^{1} {\tilde{b}}_{{k}^{′}}^{1 , H} ( l ) [ + ] … [ + ] {\tilde{b}}_{k}^{7} {\tilde{b}}_{{k}^{′}}^{7 , H} ( l ) = {δ}_{k , k} , δ ( l )$$

$$k , {k}^{′} = 0 , 1 , 2 , … , 7 ; l = 0 , 1 , … , N - 1.$$

The rest may be deduced by the similar way that the Perfect Complete Generalized Complementary Orthogonal Code Groups with the higher order such as 16, 32, 64 and so on can be generated. That is, in general, there are:

$${B}_{K} = [ \begin{matrix}{B}_{K / 2} & {B}_{K / 2} \\ {B}_{K / 2} & {\overline{B}}_{K / 2}\end{matrix} ] = {H}_{K / 2} ⊗ {B}_{2} , K = 4 , 8 , 16 , …$$

The above example uses the Hardmard matrix and the direct product of B₂, which can also be random unitary matrix in the implementation. The specific expanding can also use other equivalent operations and converting, for example:

Two methods of generating Perfect Complete Generalized Complementary Orthogonal Code Groups have been given below:

Let the elements of the matrix be the sequence, then:

Define the matrix cone , conc(A, B), the elements (the sequence) of which are composed by concatenation of the elements (the sequence) in the correspondence position of the matrixes A, B;

Define the matrix int(A, B), where, the elements (the sequence)of which are composed by interweave of the elements (the sequence) in the correspondence position of the matrixes A, B. The implication of interweave of two sequences a, b is that the parity bits of the composed new sequence are respectively generated by the bits of the sequence a and the sequence b; Suppose that Ā indicating the sequence in the matrix is the negation sequence of the corresponding sequence in A;

Then, for any Perfect Complete Generalized Complementary Code Groups B_{K}^{L} with the order of K, the length of whose component code is L, the Perfect Complete Generalized Complementary Code Groups B_{2K}^{2L} with the order 2K, the length of whose component code is 2L, can be obtained by the following two recursive methods:

$$\begin{matrix}{B}_{2 K}^{2 L} = [ \begin{matrix}conc ( {B}_{K}^{L} , {B}_{K}^{L} ) & conc ( \overline{{B}_{K}^{L}} , {B}_{K}^{L} ) \\ conc ( \overline{{B}_{K}^{L}} , {B}_{K}^{L} ) & conc ( {B}_{K}^{L} , {B}_{K}^{L} )\end{matrix} ] & 1. \\ {B}_{2 K}^{2 L} = [ \begin{matrix}int ( {B}_{K}^{L} , {B}_{K}^{L} ) & int ( \overline{{B}_{K}^{L}} , {B}_{K}^{L} ) \\ int ( \overline{{B}_{K}^{L}} , {B}_{K}^{L} ) & int ( {B}_{K}^{L} , {B}_{K}^{L} )\end{matrix} ] & 2.\end{matrix}$$

While the order is doubled in the above two methods, the length of the component code is also doubled.

Of course, in mathematics there are many methods similar to those implementation methods above which can generate high order perfect complete generalized complementary orthogonal code groups, and they are all equivalent transformation relationship, and therefore it is unnecessary to go into detail.

We can deduce that exchanging any two columns (rows) or multiple columns (rows) of B_{K} doesn't affect the generalized complementary orthogonal property.

If there isn't a same column between B_{K} and matrix after column exchanging transform of B_{K} (such as column shift transform and so on), they are orthogonal.

After constructing the generalized complementary orthogonal code groups, we expand the generalized complementary orthogonal code groups and the expanded matrix to Kronecker product, sub matrix cascade interleaving transform and other equivalent operations (including transforms), etc, to construct expanded generalized complementary orthogonal code groups. We will explain by taking an example of using the Kronecker product of generalized complementary orthogonal code groups and expanded matrix to generate expanded generalized complementary orthogonal code groups.

In the practical implementation, firstly we construct the expanded generalized complementary orthogonal code pair mate:

If the complementary orthogonal code pairs mate with original code length N₀ are:

\tilde{b}ₖ=\tilde{b}ₖ⁰[+]\tilde{b}ₖ¹, k=0, 1

Here, the codes \tilde{b}ₖ^{k′} [symbol] [\tilde{b}ₖ^{k′}(0), \tilde{b}ₖ^{k′}(1), . . . , \tilde{b}ₖ^{k′}(N₀−1)], k,k′=0, 1 are all N₀-dimensional vectors, elements \tilde{b}ₖ^{k′}(n₀)are complex scalar,

k,k′=0, 1, n₀=1, 2, . . . , N₀−1.

Let Ã be a A_{row}×A_{col.}-order basic expanded matrix,

$$\tilde{A} \tilde{=} [ \begin{matrix}{\tilde{a}}_{0} \\ \tilde{{a}_{1}} \\ ⋮ \\ {\tilde{a}}_{{A}_{row} - 1}\end{matrix} ] , {\tilde{a}}_{m} \hat{=} [ {\tilde{a}}_{m} ( 0 ) , {\tilde{a}}_{m} ( 1 ) , … , {\tilde{a}}_{m} ( {A}_{col .} - 1 ) ] , \\ m = 0 , 1 , … , {A}_{row} - 1.$$

then the length of component codes of expanded complementary orthogonal code pairs mate is N=N₀A_{col.}A_{col.}=N/N₀ (the total code length is 2N).

The method of constructing expanded complementary orthogonal code pairs mate can be as follows:

$${\tilde{B}}_{k} ( \tilde{A} ) \hat{=} [ \begin{matrix}{\tilde{b}}_{k} ( {\tilde{a}}_{0} ) \\ {\tilde{b}}_{k} ( {\tilde{a}}_{1} ) \\ ⋮ \\ {\tilde{b}}_{k} ( {\tilde{a}}_{{A}_{row} - 1} )\end{matrix} ] = {\tilde{b}}_{k}^{0} ( \tilde{A} ) [ + ] {\tilde{b}}_{k}^{1} ( \tilde{A} ) , k = 0 , 1$$

$$Where , \\ {\tilde{b}}_{k}^{{k}^{′}} ( \tilde{A} ) \hat{=} {\tilde{b}}_{k}^{{k}^{′}} ⊗ \tilde{A} = [ {\tilde{b}}_{k}^{{k}^{′}} ( 0 ) , {\tilde{b}}_{k}^{{k}^{′}} ( 1 ) , … , {\tilde{b}}_{k}^{{k}^{′}} ( {N}_{0} - 1 ) ] ⊗ \tilde{A}$$

$${\tilde{b}}_{k} ( {\tilde{a}}_{m} ) \hat{=} {\tilde{b}}_{k}^{{k}^{′}} ⊗ {\tilde{a}}_{m} = [ {\tilde{b}}_{k}^{{k}^{′}} ( 0 ) , {\tilde{b}}_{k}^{{k}^{′}} ( 1 ) , … , {\tilde{b}}_{k}^{{k}^{′}} ( {N}_{0} - 1 ) ] ⊗ {\tilde{a}}_{m}$$

$$k , {k}^{′} = 0 , 1 ; m = 0 , 1 , … , {A}_{row} - 1.$$

It can be deduced that: the expanded matrices of \tilde{b}₀ and \tilde{b}₁ can be different, even be isomorphic. For example,

$$[ \begin{matrix}a & \overline{a} \\ b & b\end{matrix} ] and [ \begin{matrix}c & \overline{c} \\ d & d\end{matrix} ]$$

are isomorphic matrices, they are similar in format, but elements are not necessarily equal.

Thus expanded complementary orthogonal code pairs mate still have 2 code groups with sizes increasing A_{row} times, i.e. there are A_{row} codes in each group, and the number of system addresses increases A_{row} times. The property of non-periodic cross-correlation functions of expanded complementary orthogonal code pairs mate (with different k) remains ideal, i.e.

\tilde{b}ₖ[ãₘ]\tilde{b}_{k′}^{H}[ã_{m′}(l)]≡0, k,k′=0, 1, ∀ k≠k′, ∀m,m′, m,m′=0, 1, . . . , A_{row}−1

Here l can even be non-integer. This property can be easily proved by using the ideal cross-correlation functions of original complementary orthogonal code groups.

But the autocorrelation functions and cross-correlation functions of the codes in the same expanded complementary orthogonal code pair mate (with the same k) are no longer ideal, determined by the property of expanded matrix's autocorrelation functions and cross-correlation functions of each row. For example, the original complementary orthogonal code pair mate and the respectively chosen expanded matrix are:

$${\tilde{B}}_{2} = [ \begin{matrix}{\tilde{b}}_{0}^{0} & {\tilde{b}}_{0}^{1} \\ {\tilde{b}}_{1}^{0} & {\tilde{b}}_{1}^{1}\end{matrix} ] = [ \begin{matrix}++ & + - \\ - + & --\end{matrix} ] , \\ \tilde{A} = [ \begin{matrix}a & b & c \\ d & e & f\end{matrix} ] , {\tilde{A}}^{′} = [ \begin{matrix}{a}^{′} & {b}^{′} & {c}^{′} \\ {d}^{′} & {e}^{′} & {f}^{′}\end{matrix} ]$$

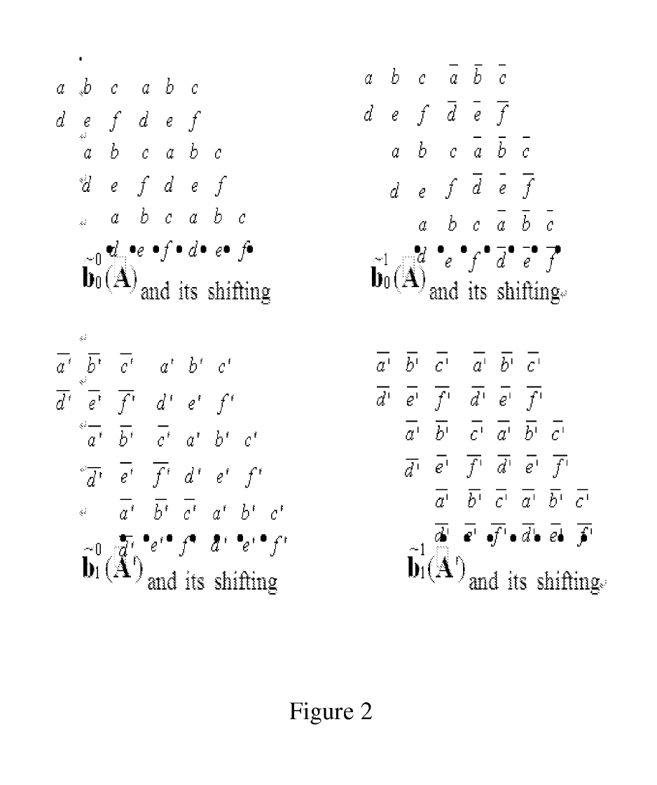

Then expanded complementary orthogonal code pair mate and their shift are shown in the FIG. 2.

In FIG. 2, by using the correlation function checking method, it can be easily found that the non-periodic cross-correlation function of expanded complementary orthogonal code pairs mate \tilde{b}₀(Ã)'s and \tilde{b}₁(Ã′)'s component codes is still ideal everywhere, but the autocorrelation functions and cross-correlation functions of codes of the same expanded complementary orthogonal code pairs mate \tilde{b}₀(Ã) or \tilde{b}₁(Ã′) are no longer ideal, determined by the autocorrelation functions and cross-correlation functions of each row of expanded matrix Ã or Ã′.

After constructing the expanded complementary orthogonal code pair mate, we construct the expanded complementary orthogonal code groups.

The method of constructing expanded complementary orthogonal code groups with component length N=N₀A_{col.} (the total length is KN) can be as follows:

$${\tilde{B}}_{k} ( \tilde{A} ) \hat{=} [ \begin{matrix}{\tilde{b}}_{k} ( {\tilde{a}}_{0} ) \\ {\tilde{b}}_{k} ( {\tilde{a}}_{1} ) \\ ⋮ \\ {\tilde{b}}_{k} ( {\tilde{a}}_{{A}_{row} - 1} )\end{matrix} ] = {\tilde{b}}_{k}^{0} ( \tilde{A} ) [ + ] {\tilde{b}}_{k}^{1} ( \tilde{A} ) [ + ] … [ + ] {\tilde{b}}_{k}^{K - 1} ( \tilde{A} ) , \\ k = 0 , 1 , … , K - 1$$

$$where \text{:}$$

$${\tilde{b}}_{k}^{{k}^{′}} ( \tilde{A} ) \hat{=} {\tilde{b}}_{k}^{{k}^{′}} ⊗ \tilde{A} = [ {\tilde{b}}_{k}^{{k}^{′}} ( 0 ) , {\tilde{b}}_{k}^{{k}^{′}} ( 1 ) , … , {\tilde{b}}_{k}^{{k}^{′}} ( {N}_{0} - 1 ) ] ⊗ \tilde{A} \\ {\tilde{b}}_{k}^{{k}^{′}} ( {\tilde{a}}_{m} ) \hat{=} {\tilde{b}}_{k}^{{k}^{′}} ⊗ {\tilde{a}}_{m} = [ {\tilde{b}}_{k}^{{k}^{′}} ( 0 ) , {\tilde{b}}_{k}^{{k}^{′}} ( 1 ) , … , {\tilde{b}}_{k}^{{k}^{′}} ( {N}_{0} - 1 ) ] ⊗ {\tilde{a}}_{m} \\ k , {k}^{′} = 0 , 1 , … , K - 1 , m = 0 , 1 , … , {A}_{row} - 1 \\ \tilde{A} \hat{=} [ \begin{matrix}{\tilde{a}}_{0} \\ \tilde{{a}_{1}} \\ ⋮ \\ {\tilde{a}}_{{A}_{row} - 1}\end{matrix} ]$$

is a A_{row}×A_{col.}-order expanded matrix,

ãₘ [symbol] [\tilde{α}ₘ(0), \tilde{α}ₘ(1), . . . , \tilde{α}ₘ(A_{col.}−1)]

is a A_{col.}=N/N₀-order row vector, m=0, 1, . . . , A_{row}−1;

The code length of \tilde{b}ₖ^{l}(Ã) k,l=0, 1, . . . , K−1 are all N=N₀A_{row}.

In the implementation, the expanded matrices of \tilde{b}ₖ are not necessarily all the same, and can be isomorphic.

Thus the expanded complementary orthogonal code pairs mate still have K code groups with sizes increasing A_{row} times, and the number of system code words available increases A_{row} times. The property of non-periodic cross-correlation functions of expanded complementary orthogonal code pairs mate (with different k) remains ideal, i.e.

\tilde{b}ₖ[ãₘ]\tilde{b}_{k′}^{T}[ã_{m′(}l)]≡0, ∀k≠k′, ∀m,m′, k,k′=0, 1, . . . , K−1, m,m′=0, 1, . . . , A_{row}−1

Here/can even be non-integer. This property can be easily proved by using the ideal cross-correlation functions of original complementary orthogonal code groups.

But the autocorrelation functions and cross-correlation functions of the codes in the same expanded complementary orthogonal code pair mate (with the same k) are no longer ideal, determined by the property of autocorrelation functions and cross-correlation functions of each row of expanded matrix Ã.

Known from the above, the number of ideal cross-correlation function's code words is increased A_{row} times by using the expanded complementary orthogonal code groups, in the same time the code length increases A_{row}. times. Hence, if the number of rows is bigger than the number of columns while implementing, i.e. A_{row.}<A_{col.}, the system capacity and code word utilization of spectrum efficiency can be greatly improved.

In an example of implementation, if we use the shifted overlapped expanded generalized complementary orthogonal code groups as user address codes, i.e. use the shifted code group with relative shift α as internal codes by using the principle of overlapped multiplexing, N/α=N₀A_{col.}/α internal codes overlapped, then code words in group and code word utilization increase N/α=N₀A_{col.}/α times. It equals to the OVTDM where code word utilization can get greatly increased. Compared to the original generalized complementary orthogonal code groups (no expanded and no overlapped multiplexing), it increases N/α=N₀A_{col.}/α times. In implementation of this invention we call the overlapped multiplexing new multiple access method as OVCDMA. OVCDMA can bring considerable high spectrum efficiency and coding gain. By assigning different expanded generalized orthogonal code groups and their shifted code groups to different cells, it can transform the pressure of multiuser joint detection of cell address users to pressure within local cell address users and it can also prevent the problem of system interference of asynchronous multiple user waveform in designing.

The code vectors of OVCDMA address code groups (with different k) have ideal cross-correlation functions, i.e. to any relative shift, the cross-correlation function of any pair code of address code groups (with different k) is 0 everywhere, and there is no need to do joint detection. The cost of high code word utilization (high capacity and high spectrum efficiency) of OVCDMA is the usage of complex multiple code joint detection for decoding of NA_{row.}/α internal codes of the same address code group (with the same k). It will be proved later that this joint detection algorithm is just the decoding algorithm of OVCDM with coding matrix as the OVCDMA expanded matrix.

Here is the computing of code word utilization with chip-level shifting (α=1 chip shift each time):

Total code length is KN₀A_{col.},
Component code length is N₀A_{col.},
Number of the maximum overlapping times of shift is N₀A_{col.},
Each shift equals to generate A_{row.} new code words,
Code word utilization of each address code groups is A_{row}/K,
The total code word utilization of system is A_{row.}.

The computing of code word utilization with non-chip-level shifting (each time shift α>1 integral chips, or α<1 fractional chip) is:

Total code length is KN₀A_{col.},
Component code length is N₀A_{col.},
Number of the maximum overlapping times of shift is N₀A_{col.}/α,
Each shift equals to generate A_{row.} new code words,
Code word utilization of each address code groups is A_{row.}/Kα,
The total code word utilization of system is A_{row.}/α.

It can be concluded that:

1) The ratio of number of expanded matrix Ã rows A_{row.} and the number of shifted chips αA_{row}/α determines the code word utilization, where code word utilization (including integral and fractional chip shift overlapping) is larger than 1 while A_{row}/a>1.

2) OVCDMA is the unique and only multiple access technology that can realize code word utilization bigger than 1.

3) Although α>1 Integral chip-level shift overlapping reduces code word utilization (system capacity and spectrum efficiency), it realizes adaptive adjust system information transmission rate in a simple way, and far exceeds any adaptive modulation and coding (AMC) technology.

4) The code word utilization of fractional chip shift overlapped multiplexing is the highest while in the same expanded matrix.

In the implementation, the overlapped multiplexing needs to satisfy the one to one correspondence relationship between input sequence and output sequence. So the choosing of expanded matrix Ã must satisfy the constraint conditions of OVCDM: parallel coding leaves the finite field, only one of A_{row} coding tap coefficients αₘ(x), m=0, 1, . . . , A_{row}−1, can be data polynomial, and the others are non-data polynomials as well as relatively-prime (linear independent).

In the implementation, we need to choose the better parallel coding matrix Ã. According to the theory of OVCDM, now repeat the principle of choosing coding matrix (i.e. expanded matrix of OVCDMA):

1) Ã leaves the finite field;
2) No more than one of the polynomial row vectors of Ã can be data polynomial, and the others are non-data polynomials as well as relatively prime (linear independent);
3) The free Euclidean distance of the coding output sequence is maximum on the given coding constraint length of the coding matrix Ã;
4) Row vectors of Ã should be samples of independent complex Gaussian vectors as much as possible.

In addition, we can choose a bigger A_{col.} (the number of columns of Ã) to make sure a smaller autocorrelation and cross-correlation secondary-peak (i.e. condition 3) and a bigger coding gain of the row vectors of Ã at the same time. This is because code word utilization of the system is only determined by A_{row} (the row number of Ã) which is unrelated to the A_{col.}. Although the over high A_{col.} can bring a bigger coding gain, it increases the states of coder exponentially, and greatly increases the complexity of optimal decoding.

Generally speaking, expanded matrix Ã with a higher universality is not necessarily optimal to any specific data signal sequence input. It's best to choose the corresponding optimal expanded matrix Ã to the specific data signal sequence input.

Thus the expanded matrix can be: unitary matrix, orthogonal matrix, or OVCDM coding matrix. Besides, the shift and overlapped multiplexing of expanded matrix cannot be only carried in chip-level, but also in fractional chip-level, i.e. the interval of shifts can be integral multiple of a chip or fractional chip.

In an implementation, if the expanded matrix is an OVCDM coding matrix, elements of the OVCDM coding matrix are non-finite field elements, and no more than one of row vector polynomials is data polynomial, and others are linear independent non-data polynomials.

In the implementation, the above OVCDMA encoding matrix may have one property or any combination of the following properties:
a) The free Euclidean distance of the coding output sequence is maximum on the given coding constraint length of the OVCDM coding matrix;
b) Each row vector of the OVCDM coding matrix is a sample of independent complex Gaussian vectors;
c) The OVCDM encoding matrix is a column matrix, or the encoding matrix of the last stage of concatenated OVCDM codes.

In the implementation of this invention, the method of multiple access transmission can be:

On the sub-channels with flat fading synchronous property, respectively transmit the acquired sending data after multiple access coding processing in the way of above multiple access coding.

In a specific implementation, due to the expanded complementary orthogonal code groups used in OVCDMA, no matter in each group or between groups, K component codes can't meet, and should have the property of flat fading synchronous in transmission. Hence, each sub-channel with flat fading synchronous characteristic can be one of the following channels or one of their hybrid channels:
a) In different periods of time flat fading, i.e. in the whole period occupied by an expanded generalized complementary orthogonal code groups, the channel pulse response is invariant;
b) In different orthogonal sub-carriers frequencies of frequency flat fading, i.e. in the whole frequency occupied by an expanded generalized complementary orthogonal code groups, the channel frequency response is invariant;
c) In different space channels of space flat fading, i.e. in the whole space occupied by an expanded generalized complementary orthogonal code groups, the channel space response is invariant;
d) In the orthogonal code division channels of flat fading in the code length, i.e. channel pulse response in the code length is invariant; the code length is equal to the time span of expanded generalized orthogonal code groups.

For example, we can arrange the K component code groups in the K orthogonal channels which can ensure flat fading in the code length:

a) The before and after K time segment in time flat fading;
b) Adjacent K orthogonal sub-carrier frequency in frequency flat fading;
c) Adjacent K orthogonal space channels in space flat fading;
d) The orthogonal code division channel of flat fading within K guaranteed code length;
e) The other flat fading mixed channels.

K component codes are organized in the adjacent K flat fading orthogonal channels within code length. Orthogonal means that component code does not meet. The flat synchronization fading within code length means that the generalized complementary among component codes is still maintained even in the random time-varying channel.

After selecting K orthogonal flat fading channels, the next most important thing is to realize the overlap multiplexing encoding of OVCDMA component code groups. The parallel encoder structure of the Kth code group the Kth component code group (k,k′=0, 1, 2, . . . , K−1) is determined by the following formula:

$${\tilde{b}}_{k}^{{k}^{′}} ( \tilde{A} ) {\tilde{b}}_{k}^{{k}^{′}} ⊗ \tilde{A} = [ {\tilde{b}}_{k}^{{k}^{′}} ( 0 ) , {\tilde{b}}_{k}^{{k}^{′}} ( 1 ) , … , {\tilde{b}}_{k}^{{k}^{′}} ( {N}_{0} - 1 ) ] ⊗ \tilde{A}$$

This is the constraint length of N=N₀A_{col.}, A_{row.} Channel parallel convolution encoder structure. Of which:

$$\tilde{A} [ \begin{matrix}{\tilde{a}}_{0} \\ \tilde{{a}_{1}} \\ ⋮ \\ {\tilde{a}}_{{A}_{row} - 1}\end{matrix} ] is a extension matrix of {A}_{row} \times {A}_{col .} order .$$

Its parallel encoding tap coefficient of the first m=0, 1, . . . A_{row}−1 is:

$${\hat{b}}_{k}^{{k}^{′}} ( {\tilde{a}}_{m} ) {\tilde{b}}_{k}^{{k}^{′}} ⊗ {\tilde{a}}_{m} = [ {\tilde{b}}_{k}^{{k}^{′}} ( 0 ) , {\tilde{b}}_{k}^{{k}^{′}} ( 1 ) , … , {\tilde{b}}_{k}^{{k}^{′}} ( {N}_{0} - 1 ) ] ⊗ {\tilde{a}}_{m}$$

$${\tilde{b}}_{k}^{{k}^{′}} ( A ) {\tilde{b}}_{k}^{{k}^{′}} ⊗ \tilde{A} = [ {\tilde{b}}_{k}^{{k}^{′}} ( 0 ) , {\tilde{b}}_{k}^{{k}^{′}} ( 1 ) , … , {\tilde{b}}_{k}^{{k}^{′}} ( {N}_{0} - 1 ) ] ⊗ \tilde{A}$$

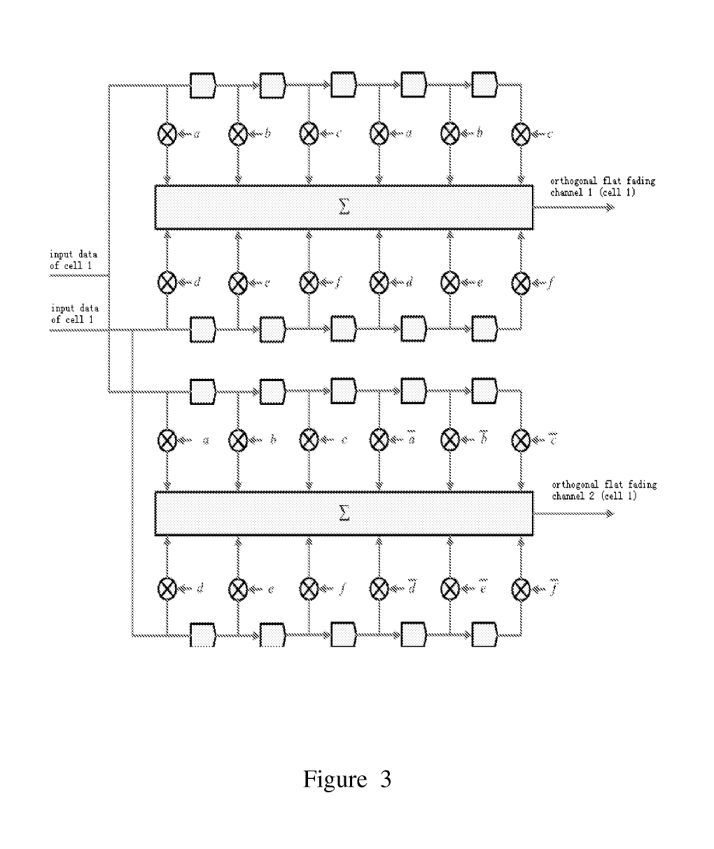

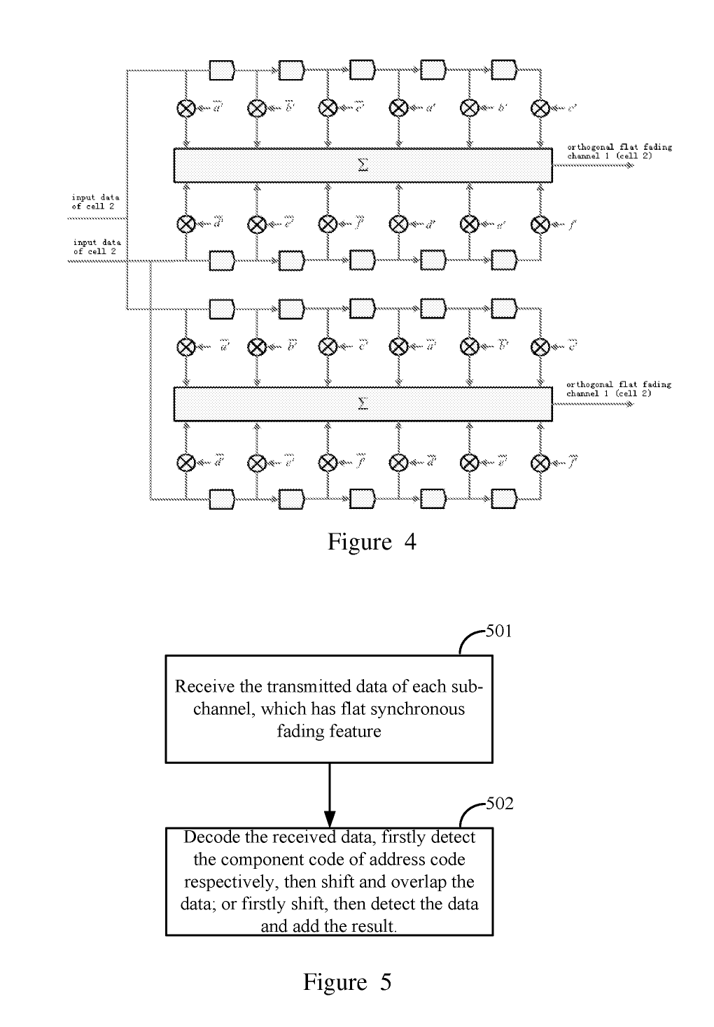

For example, FIG. 3 is a parallel convolution encoder structure of \tilde{b}₀⁰(Ã) and \tilde{b}₀¹(Ã) component code in FIG. 2 when K=2. FIG. 4 is a parallel convolution encoder structure of \tilde{b}₀⁰(Ã) and \tilde{b}₀¹(Ã) component code in FIG. 2 when K=2. FIG. 3, FIG. 4 can also be used as cell encoding structure figures which differentiate two adjacent cells OVCDMA. They all require K=2 adjacent orthogonal flat fading channels in order to reflect fully its orthogonal complement. As to how to select adjacent orthogonal flat fading channels needs more on specific circumstances. There is no specific coding tap coefficient in FIG. 3 and FIG. 4. This only states that this implementation example of the present invention is a general structure chart. It can be designed or modified according to specific needs for the distinction k>2 district or to provide k>2 address code group OVCDMA coding system structure chart.

Clock frequency of parallel convolution encoder in FIG. 3 and FIG. 4 is the chip rate. In order to adjust adaptively address user data rates, we can adjust smoothly each sub-channel data transmission rate according to different addresses channel characteristics and the transmission rate requirements by adaptively changing the address code group overlapping multiplicity. Input data rate can be a chip rate (implementation of the α=1 chip-level overlap), semi-code chip rate (implementation of the α=2 chip-level overlap) and other sub-digital chip rate.

Below is the OVCDMA propagation model:

In the OHM system, we establish extended generalized complementary orthogonal code group overlap-ping multiplexing system transmission model with the highest spectrum efficient chip-level shift (α=1) α≠1 multi-chip overlapping multiplexing situation is entirely similar. Coding sequence and matrix should first be written in time and waveforms relationship.

Known: the length of K component code of generalized complementary orthogonal code group is N₀. The selected extended matrix is:

$$\tilde{A} [ \begin{matrix}{\tilde{a}}_{0} \\ {\tilde{a}}_{1} \\ ⋮ \\ {\tilde{a}}_{{A}_{row} - 1}\end{matrix} ] is {A}_{row} \times {A}_{col .} order matrix .$$

ãₘ[\tilde{α}ₘ(0),\tilde{α}ₘ(1), . . . , \tilde{α}ₘ(A_{col.}−1)], m=0, 1, . . . , A_{row}−1, is A_{col.}N/N₀ order row vector.

To make them the time waveforms is as follows:

$${\tilde{a}}_{m} ( t ) [ {\tilde{a}}_{m} ( 0 ) G ( t ) + {\tilde{a}}_{m} ( 1 ) G ( t - {T}_{C} ) + … + {\tilde{a}}_{m} ( {A}_{col .} - 1 ) G ( t - ( {A}_{col .} - 1 ) {T}_{C} ) ]$$

$$\tilde{A} ( t ) = [ \begin{matrix}{\tilde{a}}_{0} ( t ) \\ {\tilde{a}}_{1} ( t ) \\ ⋮ \\ {\tilde{a}}_{{A}_{row} - 1} ( t )\end{matrix} ]$$

$$G ( t ) = \{ \begin{matrix}0 & t ∉ ( 0 , {T}_{C} ) \\ 1 & t ∈ ( 0 , {T}_{C} ) ,\end{matrix} \\ Where \text{:} \\ m = 0 , 1 , … , {A}_{row} - 1 , \\ {T}_{C} is the chip width .$$

So ãₘ(t), therefore the duration of Ã(t) is all A_{col.}T_{C}. That is

$${\tilde{a}}_{m} ( t ) = \{ \begin{matrix}0 & t ∉ ( 0 , {A}_{col .} {T}_{C} ) \\ \neq 0 & t ∈ ( 0 , {A}_{col .} {T}_{C} ) ,\end{matrix} \\ \tilde{A} ( t ) = \{ \begin{matrix}0 & t ∉ ( 0 , {A}_{col .} {T}_{C} ) \\ \neq 0 & t ∈ ( 0 , {A}_{col .} {T}_{C} ) .\end{matrix}$$

Now we can organize K component code groups in the adjacent K orthogonal channels to illustrate it. So when to shift according to chip-level overlap multiplexing, the k (k=0, 1, . . . , K−1) address user code group transmits signal complex envelope as follows:

$$\sqrt{2 {E}_{0}^{k}} {\sum }_{n} {\sum }_{{n}_{0} = 0}^{{N}_{0} - 1} [ {\sum }_{l = 0}^{K - 1} ] {\tilde{U}}_{n}^{k} {\tilde{b}}_{k}^{l} ( {n}_{0} ) \tilde{A} [ t - ( n + {n}_{0} {A}_{col} + 1 ) {T}_{C} ] , \\ Where \text{:} \\ [ {\sum }_{l = 0}^{K - 1} {\cdot }_{l} ] denotes complementary addition . \qquad ( 1 )$$

Ũₙ^{k}[ũ_{n,0}^{k} ũ_{n,1}^{k} . . . ũ_{n,A}_{_{row}}₋₁^{k}] is the Kth k (k=0, 1, . . . , K−1) address user. In the (nT_{C},(n+1)T_{c}), n=0, 1, . . . time slots, transmit A_{row} data in parallel. The size of the data ũ_{n,a}^{k} (a=0, 1, . . . , A_{row-1}) is Q.

E₀^{k} is every carrier launch symbol energy of this cell.

\tilde{b}ₖ^{l}(n₀) is originally the Kth complementary orthogonal code. The first n₀ symbols [\tilde{b}ₖ^{l}(0)ãₘ(t),\tilde{b}ₖ^{l}(1)ãₘ(t−A_{col.}T_{C}), . . . , \tilde{b}ₖ^{l}(N₀−1)ãₘ(t−(N₀−1)A_{col.}T_{C})] of the first l components code \tilde{b}ₖ^{l}=[\tilde{b}ₖ^{l}(0), \tilde{b}ₖ^{l}(1), . . . , \tilde{b}ₖ^{l}(N₀−1)] (k, l=0, 1, . . . , K−1, n₀=0, 1, . . . , N₀−1), is normalized waveform of extended complementary orthogonal codes the first 1 component code group the first m code.

$$\sqrt{2 {E}_{0}^{k}} {\sum }_{n} {\sum }_{{n}_{0} = 0}^{{N}_{0} - 1} [ {\sum }_{l = 0}^{K - 1} ] {\tilde{U}}_{n}^{k} {\tilde{b}}_{k}^{l} ( {n}_{0} ) \tilde{A} [ t - ( n + {n}_{0} {A}_{col} + 1 ) {T}_{C} ] , \qquad ( 1 )$$

In the implementation, it must satisfy the following conditions:

1) (l=0, 1, . . . , K−1) paths signal locate synchronous fading K orthogonal isolation channel. The addition to 1 is complementary. Due to orthogonality among orthogonal separation channel, there can be no mutual operation among different l signals.

2) Conditioned by the characteristics of average power and limited channel, where the normalization is implemented by component code of extended complementary orthogonal code, rather than the overall code.

Due to Ã A_{row}×A_{col.} order matrix, (1) is a A_{row} Channel Parallel convolution coding transfer model.

The received signal is the sum of K address user transmission signals for downlink channel. Assumed to receive the first K address signal, the received signal complex envelope is:

$${\tilde{v}}_{k} ( t ) = \frac{1}{2} {\sum }_{{k}^{′} = 0}^{K - 1} {\sum }_{n} \sqrt{2 {E}_{S , n}^{{k}^{′}}} {\sum }_{{n}_{0} = 0}^{{N}_{0} - 1} [ {{\sum }_{l = 0}}^{K - 1} ] {\tilde{U}}_{n}^{{k}^{′}} {\tilde{b}}_{{k}^{′}}^{l} ( {n}_{0} + {n}_{{k}^{′} / k} ) \cdot \tilde{A} [ t - ( n + {n}_{0} {A}_{col} + {n}_{{k}^{′} - k} + 1 ) {T}_{C} ] + \tilde{n} ( t ) , \qquad ( 2 )$$

### Where:

E_{S,n}^{k′} is energy of the first n symbol every carrier of received the first k′ (k′=0, 1, . . . , K−1) address user. Affected by time-selective fading, the symbol energy may change with time n;
ñ(t) is complex Gaussian white noise;
n_{k′/k} T_{C} is dislocation delay between the first k′ (k′=0, 1, . . . , K−1) address code group signal and the first K address code group signal. n_{k/k}=0

As shown in FIG. 5, after multiple access transmission, the receiving end multiple access decoding process can be as follows:

Step 501, receive the above mentioned sub-channel that has flat synchronization fading characteristics to transmit data;
Step 502, decode the received data. When decoding, detect the first component code of address code, and then shift overlap; or firstly shift respectively, and then take the detecting operations, and then add all the results.

Where, the above-mentioned detection operation has many ways, such as the sequence of testing operations, packet inspection operations, multi-user detection operations and so on. We will use the maximum-likelihood sequence detection algorithm of sequence test operations as an example.

At the receiving side, the primary task is to eliminate interference of other address user signals making use of extended generalized complementary code nature, and then use the maximum likelihood sequence detection algorithm to solve out the first K group address user's data sequence:

Ũₙ^{k}[ũ_{n,0}^{k}ũ_{n,1}^{k} . . . ũ_{n,A}_{_{row}}₋₁^{k}], n=0, 1, . . . ,

Overlapping of the overlapping multiplexing operation is very similar to the multi-path stretching overlap, so the overlapping multiplexing receivers, in particular, the receiver structure to eliminate of other multiple-access interference will be very similar to the Rake receiver. But there are many different points, such as:

In the traditional Rake receiver, handling multi-path load is the same data. The signal of the Rake receiver does not require generally re-treatment. And the “multi-path” in overlapping multiplexing loads different data information, and the signal of the Rake receiver must require generally re-treatment.

The multi-path of conventional Rake receiver is separable, and the “multi-path” in overlapping multiplexing is generally not separated to the address signal group, but signals of the other address signal group can separate completely.

For the received signal, it is just a linear shift superposition for different n computing. For simplicity, we can solve the situation n=0 first. The situation n≠0 is just delay shift to the situation n=0. Respectively, the received signal \tilde{ν}ₖ(t) is multiplied by

$$\frac{1}{2} \sqrt{2 {E}_{S , 0}^{k}} [ {\sum }_{l = 0}^{K - 1} ] {\tilde{b}}_{k}^{* l} ( {n}_{0} ) {G}^{0} ( t - {n}_{0} {A}_{col .} {T}_{C} ) , \\ Where \text{:} \\ {G}^{0} ( t ) = \{ \begin{matrix}0 & t ∉ ( 0 , {A}_{col} {T}_{C} ) \\ 1 & t ∈ ( 0 , {A}_{col .} {T}_{C} ) ,\end{matrix} \\ {n}_{0} = 0 , 1 , … , {N}_{0} - 1 \qquad ( 3 )$$

This is N₀ non-overlapping local signals with interval A_{col.}T_{C}. For each specific c, its product result is:

$$\begin{matrix} \frac{1}{2} {\tilde{v}}_{k} ( t ) \sqrt{2 {E}_{S , 0}^{k}} [ {\sum }_{l = 0}^{K - 1} ] {\tilde{b}}_{k}^{* l} ( {n}_{0} ) {G}^{0} ( t - {n}_{0} {A}_{col .} {T}_{C} ) = {\tilde{D}}_{k}^{{n}_{0}} ( t ) + {\tilde{n}}_{0} ( t ) , \\ {n}_{0} = 0 , 1 , … , {N}_{0} - 1 \\ Where : \\ {\tilde{D}}_{k}^{{n}_{0}} ( t ) = {\sum }_{{k}^{′} = 0}^{K - 1} \sqrt{{E}_{S , 0}^{{k}^{′ }} {E}_{S , 0}^{k}} [ {\sum }_{l = 0}^{K - 1} ] {\tilde{U}}_{0}^{{k}^{′}} {\tilde{b}}_{k}^{* l} ( {n}_{0} ) {\tilde{b}}_{{k}^{′}}^{l} ( {n}_{0} + {n}_{{k}^{′} / k} ) {\tilde{A}}_{{k}^{′} - k} ( t - {n}_{0} {A}_{col .} {T}_{C} ) & ( 4 ) \\ {n}_{0} = 0 , 1 , … , {N}_{0} - 1 & ( 5 ) \\ {\tilde{A}}_{{k}^{′} - k} ( t - {n}_{0} {A}_{col .} {T}_{C} ) = {G}^{0} ( t - {n}_{0} {A}_{col .} {T}_{C} ) \tilde{A} ( t - ( {n}_{{k}^{′} - k} + {n}_{0} {A}_{col .} ) {T}_{C} ) , & ( 6 )\end{matrix}$$

When k′=k, A_{k′-k}(t)=A(t).

\tilde{D}ₖⁿ^{₀}(t) (n₀=0, 1, . . . , N₀−1) is N₀ non-overlapping time waveform whose interval A_{col.}T_{C}. To take advantage of the nature of generalized complementary orthogonal code group to completely eliminate the signal interference of adjacent address code group, we implement the following shift and sum to \tilde{D}ₖⁿ^{₀}(t), that is, “Rake” combined operation.

$${\sum }_{{n}_{0} = 0}^{{N}_{0} - 1} {\tilde{D}}_{k}^{{n}_{0}} ( t - ( {N}_{0} - {n}_{0} - 1 ) {A}_{col .} {T}_{C} ) , \qquad ( 7 )$$

The above-mentioned shift and sum signal in the last slot the first k address code group receiver [(N₀−1)A_{col.}T_{C},N₀A_{col.}T_{C}], that is, the “Rake” combined signal (excluding noise) is

$${\sum }_{{k}^{′} = 0}^{K - 1} \sqrt{{E}_{S , 0}^{{k}^{′}} {E}_{S , 0}^{k}} {\sum }_{{n}_{0} = 0}^{{N}_{0} - 1} [ {\sum }_{l = 0}^{K - 1} ] {\tilde{U}}_{0}^{{k}^{′}} {b}_{k}^{* l} ( {n}_{0} ) {\tilde{b}}_{{k}^{′} - k}^{* l} ( {n}_{0} + {n}_{{k}^{′} / k} ) {\tilde{A}}_{{k}^{′} - k} ( t - ( {N}_{0} - 1 ) {A}_{col .} {T}_{C} ) , \qquad ( 8 )$$

Under the expanded generalized complementary orthogonal code group, we know that for any relative shift, the following relations have been established:

$${\sum }_{{n}_{0} = 0}^{{N}_{0} - 1} [ {\sum }_{l = 0}^{K - 1} ] {\tilde{b}}_{k}^{* l} ( {n}_{0} ) {\tilde{b}}_{{k}^{′}}^{l} ( {n}_{0} + {n}_{{k}^{′} / k} ) = \{ \begin{matrix}K & k = {k}^{′} \\ 0 & k \neq {k}^{′} , ∀ {n}_{{k}^{′} / k} ,\end{matrix} \qquad ( 9 )$$

The above-mentioned “Rake” combined signal (excluding noise) the first k address code group receiver [(N₀−1)A_{col.}T_{C},N₀A_{col.}T_{C}] is

KE_{S,0}^{k}Ũ₀^{k}Ã(t−(N₀−1)A_{col.}T_{C})=KE_{s,0}^{k}Ũ₀^{k}Ã₀(t), (10)

Where: [symbol] ₀(t)=Ã(t−(N₀−1)A_{col.},T_{C}).

To completely eliminate the signal interference of adjacent the other K−1 address code group.

Similarly, the above-mentioned “Rake” combined signal (excluding noise) the first k address code group receiver [1+(N₀−1)A_{col.})T_{C},(1+N₀A_{col.})T_{C}] is

KE_{S,1}^{k}Ũₗ^{k}Ã₀(t−T_{C}), (11)

The above-mentioned “Rake” combined signal (excluding noise) the first k address code group receiver [(2+(N₀−1)A_{col.})T_{C},(2+N₀A_{col.})T_{C}] is

$${KE}_{S , 1}^{k} {\tilde{U}}_{1}^{k} {\tilde{A}}_{0} ( t - 2 {T}_{C} ) , \\ … … … … \qquad ( 12 )$$

Finally, the above-mentioned in the first k address code group signal receiver “Rake” combined signal sequence (excluding noise) will be:

$$K {\sum }_{n} {E}_{S , n}^{k} {\tilde{U}}_{n}^{k} {\tilde{A}}_{0} ( t - {nT}_{C} ) , \qquad ( 13 )$$

There are no other address code group signals, which is the OVCDM coding output signal that belongs to the address code group signal A_{row} road parallel data input, constraint length of A_{col.}. In order to solve the data vector

Ũₙ^{k}[ũ_{n,0}^{k}ũ_{n,1}^{k} . . . ũ_{n,A}_{_{row}}₋₁^{k}], n=0, 1, . . . ; k=0, 1, . . . , k−1

The final step is OVCDM decoding for the encoding matrix Ã, that is OVCDM parallel decoding convolution codes to

$$K {\sum }_{n} {E}_{S , n}^{k} {\tilde{U}}_{n}^{k} {\tilde{A}}_{0} ( t - {nT}_{C} ) .$$

In fact, no matter how much extended generalized complementary code length N=N₀A_{col.}, when the relative shift is larger than A_{col.}, regardless of the autocorrelation function or the cross-correlation function, their sub-peaks will all be 0, which is the real reason for OVCDM coding constraint length being only A_{col.}.

In this way, after the combined process of the Rake receiver, the output signal would be coded signal with interference of all the other address code group signals eliminated. The encoding model will be the A_{row} (the row number of Ã) parallel convolution encoder, where the tap coefficient vector of the convolution encoder is corresponding with the row vector of the expansion matrix Ã, and the encoding constraint length is A_{col.} which is the number of columns of Ã. In each shift by chip-level, the total number of states for the A_{row} road (the row number of Ã) parallel convolution encoder is 2^{QA}^{_{row}}^{(A}^{_{col.}}⁻¹⁾, and the register shifts according to the chip rate. If each overlapping shift is taken by two chips, then the input data rate of the parallel shift register decreases by half, which is equivalent to inserting the A_{row} parallel zero data at intervals in the said A_{row} parallel data. Then the total number of states of the parallel convolution encoder turns into 2^{QA}^{_{row}}^{(A}^{_{col.}}^{-1)/2}. This can be deduced on the condition of overlapping shift on several chips. When the chip number of each shift is larger than A_{col.}, the A_{row} parallel convolution encoders does not exist.

In the above implementation example, the receiver receives the signal then decodes data, where the decoding process firstly detects the component code of the address code, then shifts and overlaps the data. At the same time, the implementation can firstly shift the data, then detect the signal, lastly overlap the calculation results.

That is, after detecting the signal corresponding to n₀=0, 1, . . . N₀−1, the Rake receiver can delay and add together all the calculation results, or delay the received signal and take the detection operation, then add together all the data, where the delay interval of the tap delay line is A_{col.}T_{C}, and there are N₀−1 delay units. The output of the last delay unit is the detect result of n₀=0; the output of the last but one delay unit is the detect result of n₀=1; . . . ; the output of the unit without delay operation is the detect result of n₀=N₀−1, and the output data is added together directly, finally we get the total output.

In addition, we can deduce that the expansion matrix A is actually the last level encoding matrix of a serial or array concatenated OVCDM. For example, the interleaved constellation multiplexing coding matrix of the second level is equivalent to A, which is just the column matrix, namely, A_{col.}=1. However, when the transmitter implements the coding operation, it needs to use the expanded generalized complementary orthogonal code group. The two codes are equivalent only in the decoding operation, and it does not mean that the encoding can also be replaced by the equivalent code.

Also we can deduce that the final decoding algorithm is OVCDM decoding algorithm whose encoding matrix is the OVCDMA expansion matrix.

For the decoding address code group signal, the encoding model will be the A_{row} (the row number of Ã) parallel convolution encoder, where the tap coefficient vectors of the convolution encoder are respectively corresponding to the row vectors of expansion matrix Ã, whose coding constraint length are all A_{col.}. This is just the OVCDM model.

There are some additional explanations as follows:

1) The implementation issues of the Rake receiver:

In practice, the Rake receiver does not delay and add all the results as the formula derived in the text after the detect operation. On the contrary, it firstly delays the received signal through the tap delay line, then takes the detect operation respectively, lastly adds the signal directly. The interval of the delay unit of the tap delay line is A_{col.}T_{C}, and the total delay unit is N₀−1.

The output of the last delay unit is the detect result of n₀=0; the output of the last but one delay unit is the detect result of n₀=1; . . . ; the output of the unit without delay operation is the detect result of n₀N₀−1, and the output data is added together directly, then we get the total output.

2) The expansion matrix Ã is actually the last level encoding matrix of a serial or array concatenated OVCDM. For example, the interleaved constellation multiplexing coding matrix of the second level is equivalent to A, which is just the column matrix, that is, A_{col.}=1. However, when the transmitter implements the coding operation, it needs to use the expanded generalized complementary orthogonal code group. The two codes are equivalent only in the decoding operation, and it does not mean that the encoding can also be replaced by the equivalent code.

In addition, during the practical implementation procedure, we can take the equalization process before or after decoding operation, so as to ensure the accurate realization of complementary orthogonality, and assure that the orthogonal channels within the code length are all flat fading channels.

The people with ordinary skills in the art can understand that the total or part of the implementation methods mentioned above can be achieved through the programming operation which can instruct the related hardware. Besides, the program as set forth above can be stored in a computer-readable storage medium, and the program execution may include the total or part of the steps of the aforementioned implementation methods, where the storage media may include: ROM, RAM, disk, CD-ROM and so on.

The implementation of the present invention also provides a multiple access coding device, multiple access transmission equipment, a multiple access decoding devices and a communication system. As the theory principle of the devices and the system is similar to the above mentioned method, we can refer to the present implementation method as set forth above.

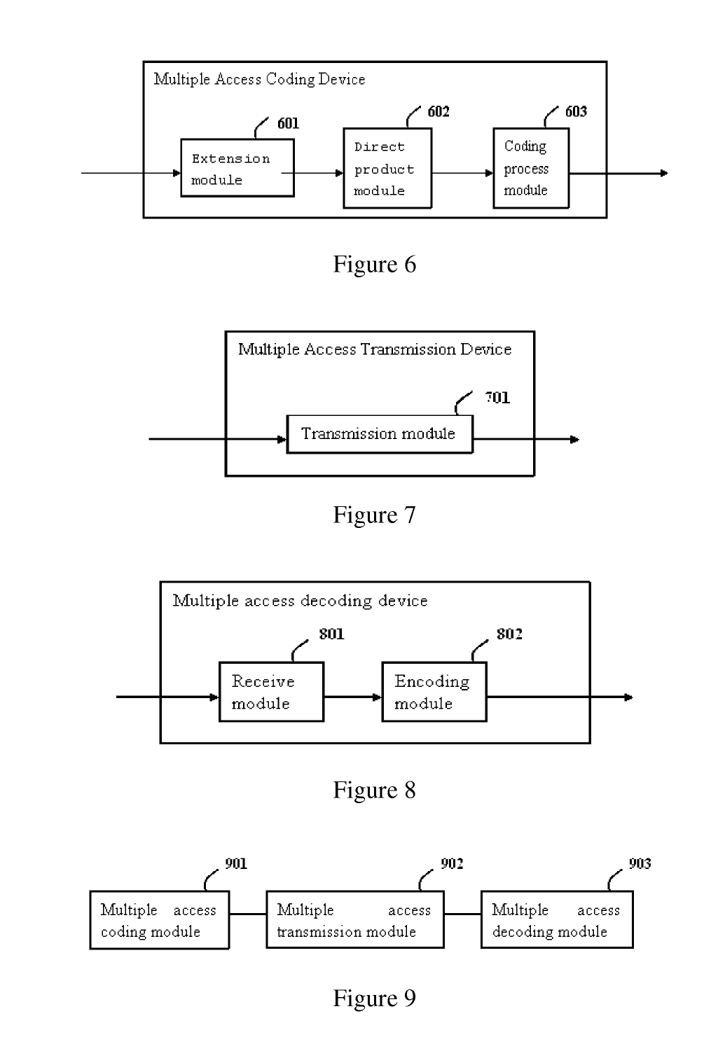

The structure of the multiple access coding device related to the present invention is shown in FIG. 6. The device may include:
a) Expansion module 601, is used to expand the perfect complementary orthogonal code dual and generate the generalized complementary orthogonal code group, wherein the auto-correlation function of the generalized complementary orthogonal code group is the impulse response function, and the cross-correlation function is zero everywhere;
b) Direct product module 602, is used to expand the generalized complementary orthogonal code group and the expansion matrix expansion, and generate the expanded generalized complementary orthogonal code group;
c) Encoding processing module 603 is used to multiple access encoding process employing the expanded generalized complementary orthogonal code group and its shift code group for the transmission data.

In an implementation example of the present invention, the encoding processing module 603 can also be used for:
a) The overlapping expansion generalized complementary orthogonal code group can be used as the user address code;
b) The expansion matrix described above can be unitary matrix, orthogonal matrix, or overlapping OVCDM encoding matrix and the overlapping interval of the expansion matrix is the integer times of the number of the chip or fraction chip.

In an implementation example of the present invention, the elements of said OVCDM encoding matrix are beyond the finite field, and there is at most a data polynomial in the polynomial of each row vector, the rest are all linearly independent non-data polynomials.

In an implementation example of the present invention, the OVCDM encoding matrix also has one of the following attributes or any combination of:
a) In a given code constraint length, the free Euclidean distance is maximum between the encoded output sequences;
b) The row vectors of the OVCDM encoding matrix are sample values of the independent complex Gaussian vectors;
c) The OVCDM encoding matrix is the column matrix whose row number is greater than the column number, or the last level encoding matrix of the concatenated OVCDM code.

In an implementation example of the present invention, the expansion matrixes with different addresses are isomorphic matrix.

The structure of the multiple access transmission device related to the present invention is shown in FIG. 7. The device may include:

Transmission module 701 is used to transmit data after the multiple accesses processing of the aforementioned transmission device in sub-channels with flat synchronized fading characteristics.

In an implementation example of the present invention, if the overlapping expansion generalized complementary orthogonal code group is used as the user address code, the above described multiple access transmission devices may also include:

Rate adjustment module, is used to smoothly adjust the data transmission rate of the sub-channels by adaptively changing the overlapping multiplicity of the address code group, according to the channel characteristics and data rate requirements of users with different addresses.

In an implementation example of the present invention, the aforementioned sub-channels with flat synchronized fading characteristics can be one of the following channels or their mixed channel:

a) Different time periods with time flat fading characteristics;
b) Different orthogonal sub-carrier frequencies with frequency flat fading characteristics;
c) Different spatial channel with space flat fading characteristics;
d) Orthogonal code division channel with flat fading characteristics during the code length.

The structure of the multiple access decoding device related to the present invention is shown in FIG. 8. The device may include:
a) Receiver module 801 is used to receive the data from the sub-channels with flat synchronized fading characteristics;
b) Decoding module 802 is used to decode the received data, where the decoding process firstly detects the component code of the address code, then shifts and overlaps the data. At the same time, the implementation can firstly shift the data, then detect the signal, lastly overlap the calculation results.

In an implementation example of the present invention, the aforementioned detecting operation includes sequence detection operation, packet detection operation, or multi-user detection operation.

In an implementation example of the present invention, the above mentioned multiple accesses decoding device may also include:

Equalization processing module is used to take the equalization process before or after decoding operation.

The structure of the communication system related to the present invention is shown in FIG. 9. The system may include:

Multiple access encoding unit 901, is used to expand the perfect complementary orthogonal code dual and generate the generalized complementary orthogonal code group, wherein the auto-correlation function of the generalized complementary orthogonal code group is the impulse response function, and the cross-correlation function is zero everywhere; to expand the generalized complementary orthogonal code group and the expansion matrix expansion, and generate the expanded generalized complementary orthogonal code group; to take the multiple access encoding process for the transmission data employing the expanded generalized complementary orthogonal code group and its shift code group.

Multiple access transmission equipment 902 is used to transmit data after the multiple accesses processing of said transmission device in sub-channels with flat synchronized fading characteristics.

Multiple decoding equipment 903 is used to receive the data from the sub-channels with flat synchronized fading characteristics; to decode the received data, where the decoding process firstly detects the component code of the address code, then shifts and overlaps the data. Or, the implementation can firstly shift the data, then detect the signal, lastly overlap the calculation results.

In an implementation example of the present invention, the above described multiple access encoding device 901 is also used to:
a) The overlapping expansion generalized complementary orthogonal code group can be used as the user address code;
b) The expansion matrix described above can be unitary matrix, orthogonal matrix, or overlapping OVCDM encoding matrix and the overlapping interval of the expansion matrix is the integer times of the number of the chip or fraction chip.

In an implementation example of the present invention, the elements of aforementioned OVCDM encoding matrix are beyond the finite field, and there is at most a data polynomial in the polynomial of each row vector, the rest are all linearly independent non-data polynomials.

In an implementation example of the present invention, the OVCDM encoding matrix also has one of the following attributes or any combination of:
a) In a given code constraint length, the free Euclidean distance is maximum between the encoded output sequences;
b) The row vectors of the OVCDM encoding matrix are sample values of the independent complex Gaussian vectors;
c) The OVCDM encoding matrix is the column matrix, the matrix whose row number is greater than the column number, or the last level encoding matrix of the concatenated OVCDM code.

In an implementation example of the present invention, the expansion matrixes with different addresses are isomorphic matrix.

In an implementation example of the present invention, if the overlapping expansion generalized complementary orthogonal code group is used as the user address code, the above described multiple access transmission devices 902 is also used to smoothly adjust the data transmission rate of the sub-channels by adaptively changing the overlapping multiplicity of the address code group, according to the channel characteristics and data rate requirements of users with different addresses.

In an implementation example of the present invention, the aforementioned sub-channels with flat synchronized fading characteristics can be one of the following channels or their mixing channel:

a) Different time periods with time flat fading characteristics;
b) Different orthogonal sub-carrier frequencies with frequency flat fading characteristics;
c) Different spatial channel with space flat fading characteristics;
d) Orthogonal code division channel with flat fading characteristics during the code length.

In an implementation example of the present invention, the aforementioned detecting operation includes sequence detection operation, packet detection operation, or multi-user detection operation.

In an implementation example of the present invention, the above mentioned multiple accesses decoding device 903 is used to take the equalization process before or after decoding operation.

In order to get greater capacity and spectrum efficiency, and more flexible multiple access transmission for the wireless digital mobile communication systems, the present invention takes the multiple access encoding process for the transmission data employing the expanded generalized complementary orthogonal code group and its shift code group. No matter using the overlapping with the chip or fraction chip level, the system utilization ratio of the address code can be greater than one, which can achieve the purpose of sharing the channel capacity C, so that the system can have system capacity and spectral efficiency far higher than those of the 3G or even 4G. Besides, we can shift the pressure of multi-user detection from inter-cell address users to intra-cell address users by allocating the generalized complementary orthogonal code group and its shift code group to different cells; and the encoding scheme can make the cross-correlation function between address code group be ideal in a generalized complementary sense, which can avoid interference between address users; and the auto-correlation function between address code group can realize coding constraint relation with high coding gain, which can boost the transmission reliability and greatly enhance the system performance

The address code group in the implementation of the present invention still has the ideal characteristics, even in a pure asynchronous condition. Besides, the requirement for accuracy synchronization is very low in the quasi-asynchronous or rough synchronous conditions. The implementation of the present invention also needs the practical requirement and channel propagation conditions, where the transmission rate of different users can realize smooth and flexible change, merely rely on changing the overlapping multiplicity of the address code groups.

The present invention can be used not only in the DS-CDMA system, but also in the OFDM system and even other narrow band systems.

The specific implementation as mentioned above explains the purpose of the present invention, technical programs and beneficial effects in further detail, while, it should be understood that the invention and its embodiments are not restricted to the above specific implementations but may vary within the scope of the claims. Any changes, equivalent replacing, improving within the spirit and principles of the present invention, should be included within the scope of protection of the present invention.

Since many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents.

Furthermore, many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific examples of the embodiments disclosed and that modifications and other embodiments are intended to be included within the scope of the appended claims. Although specific terms are employed herein, they are used in a generic and descriptive sense only and not for purposes of limitation.

1. A multiple access encoding method for wireless mobile communications, wherein said method comprising:
a) Expanding a complete complementary orthogonal code mate to generate generalized complementary orthogonal code group where an auto-correlation function of said generalized complementary orthogonal code group is an impulse response, and its cross-correlation function is zero everywhere,
b) Expanding said generalized complementary orthogonal code group and an extension matrix to generate an expanded generalized complementary orthogonal code group, and
c) Executing a multiple access encoding to transmitted data by using said expanded generalized complementary orthogonal code group and its shift code group.

2. A method as recited in claim 1 wherein said multiple access encoding to said transmitted data by using said expanded generalized complementary orthogonal code group and said shift code group further comprising:
a) Using each said expanded generalized complementary orthogonal code group with shift overlapping as a signature code of an user, and
b) Said extension matrix including unitary matrix, orthogonal matrix, or overlapping coding OVCDM (Overlapped Code Division Multiple Access) encoding matrix, with the interval of said extension matrix shifting being chip or integer times of fraction chip.

3. A method as recited in claim 2 wherein elements in said OVCDM encoding matrix are non-finite-field elements, and there is a data polynomial for each line vector polynomial at least, and others are linearly independent non-data polynomial.

4. A method as recited in claim 2 wherein said OVCDM coding matrix comprising one of the attributes or any combination of them:
a) When the coding constraint length of said OVCDM coding matrix given, the free Euclidean distance between an encoded output sequences being maximum,
b) Each line vector of said OVCDM encoding matrix being the sample value of the complex Gaussian vectors independent with each other, and
c) Said OVCDM coding matrix being column matrix, or a last-level coding matrix of a cascaded OVCDM code.

5. A method as recited in claim 1 wherein said extension matrix of different addresses are isomorphism matrix.

6. A method as recited in claims 1 to 4 wherein in each sub-channel with flat synchronous fading characteristic, separately transmitting said transmitted data after multiple access encoding processing.

7. A method as recited in claim 6 wherein when doing said multiple access encoding processing, using each said expanded generalized complementary orthogonal code group with shift overlapping as said signature code of said user, then a transmission also comprises smoothly adjusting the bit transmission rate by adaptively changing the overlapping multiplicity of said signature code group, according to channel characteristic and the demanding bit transmission rate of said user with different address.

8. A method as recited in claim 6 wherein said each sub-channel with flat synchronous fading characteristic comprising one of the following channels or their combination:
a) Different time periods with time flat fading,
b) Different orthogonal subcarrier frequencies with frequency flat fading;
c) Different space channel with space flat fading, and
d) Orthogonal code division channel with flat fading characteristic in the code length.

9. A multiple access decoding method for wireless mobile communications, wherein said method comprising:
a) Receiving data separately transmitted in sub-channels with flat synchronous fading characteristic, and
b) Decoding received data by firstly detecting component codes of a signature code separately, then shifting and adding them together or shifting separately first, then detecting and adding the operation results together.

10. A method as recited in claim 9 wherein said detection operation including sequence detection operation, packet detection operation, or multi-user detection operation.

11. A method as recited in claim 9 wherein before or after said decoding, taking the equalization processing.

12. A multiple access encoding equipment as recited in claim 1, wherein said system comprising:
a) Extension module used to expand said complete complementary orthogonal code mate to generate said generalized complementary orthogonal code group wherein said auto-correlation function of said generalized complementary orthogonal code group is said impulse function, and said cross-correlation function is zero everywhere,
b) Direct product module used to expand said generalized complementary orthogonal code group and said extension matrix to generate said expanded generalized complementary orthogonal code group, and
c) Encoding processing module used to perform multiple access encoding procedure for said transmitted data by using said expanded generalized complementary orthogonal code group and said shifting code group.

13. A method as recited in claim 12 wherein said encoding processing module further comprising:
a) Module using each said expanded generalized complementary orthogonal code group with shift overlapping as said signature code of said user, and
b) Said extension matrix module including unitary matrix, orthogonal matrix, or overlapping coding OVCDM (Overlapped Code Division Multiple Access) coding matrix, with the interval of said extension matrix shifting being chip or integer multiple of fraction chip.

14. A method as recited in claim 13 wherein elements in said OVCDM coding matrix are non-finite-field elements, and there is a data polynomial for each line vector polynomial at least, and others are linearly independent non-data polynomial.

15. A method as recited in claim 13 wherein said OVCDM coding matrix module further comprising one of the attributes or any combination of them:
a) When the coding constraint length of said OVCDM coding matrix given, the free Euclidean distance between encoded output sequences being maximum,
b) Each line vector of said OVCDM coding matrix being a sample value of complex Gaussian vectors independent with each other, and
c) Said OVCDM coding matrix being column matrix whose number of lines greater than number of columns or the last-level coding matrix of a cascaded OVCDM code.

16. A method as recited in claim 12 wherein said extension matrix module of different addresses has isomorphic matrix.

17. A system as recited in claim 12 wherein said encoding equipment further comprises transmission module used to separately transmit said transmitted data after multiple access encoding processing in each said sub-channel with flat synchronous fading characteristic.

18. A multiple access decoding equipment as recited in claim 9, wherein said system comprising:
a) Receiving module used to receive data separately transmitted in said sub-channels with flat synchronous fading characteristic, and
b) Decoding module used to do detection operation to said component codes of said signature code separately first, then shifting and adding them together or shifting separately first, then detecting and adding the result together.

19. A system as recited in claim 18 wherein said decoding equipment further comprising equalization module used to do equalization before and after decoding.

20. A method as recited in claim 1 and claim 9 wherein said encoding method and said decoding method can be utilized in or converged with any wireless multiple access technologies including Frequency Division Multiple Access (FDMA), Orthogonal Frequency Division Multiple Access (OFDMA), Time division Multiple Access (TDMA), Code Division Multiple Access (CDMA) and Space Division Multiple Access (SDMA).
